(19) United States
(12) Patent Application Publication
(10) Pub. No.: US 2020/0213005 A1
(43) Pub. Date: Jul. 2, 2020

(54) INTERCHANGEABLE MODULAR ASSEMBLY DEVICE

(71) Applicant: SmartLabs, Inc., Irvine, CA (US)

(72) Inventors: Daniel Brian Cregg, Newport Beach, CA (US); Robert E. Slick, Costa Mesa, CA (US); Blake Arlo Spangenberg, Huntington Beach, CA (US); Christopher Jan Perez, Diamond Bar, CA (US)

(21) Appl. No.: 16/814,728

(22) Filed: Mar. 10, 2020

Related U.S. Application Data
(63) Continuation-in-part of application No. 16/213,097, filed on Dec. 7, 2018, now Pat. No. 10,594,398.
Application No. 16/213,097 is a continuation of application No. 15/808,356, filed on Nov. 9, 2017, now Pat. No. 10,181,902.
Application No. 15/808,356 is a continuation of application No. 15/668,168, filed on Aug. 3, 2017, now abandoned.
Application No. 15/668,168 is a continuation of application No. 15/187,010, filed on Jun. 20, 2016, now Pat. No. 9,755,744.
Application No. 15/187,010 is a continuation of application No. 14/952,147, filed on Nov. 25, 2015, now Pat. No. 9,401,763.
Application No. 14/952,147 is a continuation of application No. 13/920,894, filed on Jun. 18, 2013, now Pat. No. 9,232,615.
Application No. 13/920,894 is a continuation-in-part of application No. 16/718,588, filed on Dec. 18, 2019.
Application No. 16/718,588 is a continuation of application No. 16/406,595, filed on May 8, 2019, now abandoned.
Application No. 16/406,595 is a continuation of application No. 15/953,724, filed on Apr. 16, 2018, now abandoned.
(60) Provisional application No. 61/661,722, filed on Jul. 3, 2012.
(60) Provisional application No. 62/486,083, filed on Apr. 17, 2017.

(51) Int. Cl. H04B 10/116; H05B 45/10; H05B 45/37; H05B 47/19; H05B 47/185; H04L 12/26; H04W 24/08

(52) U.S. Cl. CPC H04B 10/116; H05B 45/10; H05B 45/37; H04W 24/08; H05B 47/185; H04L 43/16; H05B 47/19

(57) ABSTRACT

An LED illumination device is configured to receive coded messages by at least one of radio signals in free space, electrically conducted signals by wire, and light wave propagated signals in free space, process the coded messages, and transmit the coded messages by two or more of radio signals in free space, electrically conducted signals by wire, and light wave propagated signals in free space.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

This disclosure relates to the field of smart home devices and further relates to the interchangeability of a communication module for processing messages.

Communication among low-cost devices is useful in many applications. For example, in a home environment, room occupancy sensors, light switches, lamps, lamp dimmers, and a gateway to the Internet can all work together if they are in communication.

In addition, current LED illumination sources are either non-dimmable or use expensive and inefficient phase angle detection to provide dimming. Dimming levels are determined by the analog phase angle of the chopped sine wave that can vary depending on the alternating current voltage (VAC) powering the lighting circuit, the power line frequency, and the temperature of the individual illumination source. As a result, each illumination source in a bank of illumination sources, although driven from the same phase angle dimmer, may have a different brightness. Further, current illumination sources are inefficient because they store energy during the chopped phases of the main power's alternating current. The large components required to store the energy create undesirable physical dimensions for LED illumination sources.

Further, residential wiring is installed during the construction phase of home building according to the building codes. The electrical wiring connects a power source to electrical junction boxes placed throughout the house. Based on anticipated needs, some electrical junction boxes may connect to electrical devices, such as sockets, that permit direct electrical connection. Other electrical junction boxes may connect to electrical devices that control the access to the electrical power, such as switches. Once the wiring is installed, it is covered up during the finishing phase. Homeowners frequently find it difficult to repair, replace, or upgrade the existing electrical system because of concerns over safety. Further, some homeowners do not know the proper techniques to change home wiring.

### SUMMARY

The innovations described in the claims each have several aspects, no single one of which is solely responsible for the desirable attributes. Without limiting the scope of the claims, some prominent features of this disclosure will now be briefly described.

The devices communicate over a communication network using one or more communication mediums to increase the likelihood that messages will be received by the intended recipient. A communication module of the device can be interchanged according to the developments of communication protocols.

Certain embodiments relate to a system to receive and transmit data and commands over a network. The system comprises a mesh network and a plurality of network devices. The network device comprises an enclosure, a first connector, a second connector, a communication device and a controller. The first connector is mounted in the enclosure and is configured to connect to an electric power source. The communication device comprises a sensor module configured to detect a first condition and a communication module is configured to receive coded messages from and transmit coded messages to another network device over the mesh network using a first communication protocol. The communication device comprises the third connector configured to detachably couple to the second connector and first processing circuitry configured to process the coded messages to provide control signals via the second and the third connectors. The communication device is configured to be interchangeable with another communication device of a plurality of communication devices that use a second communication protocol that is different from the first communication protocol. The controller is in communication with the communication module and comprises second processing circuitry configured to control operations of the network device responsive to the control signals.

In an embodiment, the network device further comprises powerline communication circuitry configured to receive messages from and transmit messages over the mesh network via the first connector. The messages is modulated onto a carrier signal and the data modulated carrier signal being added to the powerline waveform.

In an embodiment, each of the network devices is configured to transmit and receive the coded messages synchronously over the mesh network using powerline signaling and the first communication protocol based on zero crossings of the powerline waveform. Each of the first and the second communication protocols include at least one of a home automation protocol, a mesh network protocol, an RF protocol, Bluetooth, a near-field communication protocol, Wi-Fi, a 4G LTE protocol and a 5G wireless protocol. The controller comprises a memory. The controller is configured to communicate with said another communication device to retrieve information from said another communication device and to store the information in the memory in response to determining that the communication device is interchanged with said another communication device. The network device comprises a fourth connector exposed from the enclosure and the sensor module further comprises a fifth connector detachably coupled to the fourth connector to allow interchangeability of the sensor module with another sensor module that is configured to detect a second condition that is different from the first condition. At least one of the network devices is an in-wall modular assembly comprising a mounting bracket configured to attach to an electrical box that is mounted in a house. The mounting bracket is configured to electrically connect to the first connector.

Certain embodiments relate to a network device to receive and transmit data and commands over a network. The network device comprises an enclosure, a first connector, a second connector, a communication device and a controller. The first connector is mounted in the enclosure and is configured to connect to an electric power source. The communication device comprises a communication module is configured to receive coded messages from and transmit coded messages to another network device over the mesh network using a first communication protocol. The communication device comprises the third connector configured to detachably couple to the second connector and first processing circuitry configured to process the coded messages to provide control signals via the second and the third connectors. The communication device is configured to be interchangeable with another communication device of a plurality of communication devices that use a second communication protocol that is different from the first communication protocol. The controller is in communication with the communication module and comprises second processing circuitry configured to control operations of the network device responsive to the control signals.

In an embodiment, the network device further comprises powerline communication circuitry configured to receive messages from and transmit messages over the mesh network via the first connector. The messages is modulated onto a carrier signal and the data modulated carrier signal being added to the powerline waveform.

In an embodiment, each of the network devices is configured to transmit and receive the coded messages synchronously over the mesh network using powerline signaling and the first communication protocol based on zero crossings of the powerline waveform. Each of the first and the second communication protocols include at least one of a home automation protocol, a mesh network protocol, an RF protocol, Bluetooth, a near-field communication protocol, Wi-Fi, a 4G LTE protocol and a 5G wireless protocol.

In an embodiment, the communication further comprises a sensor module that is configured to detect a first condition and a fourth connector exposed from the enclosure. The sensor module further comprises a fifth connector detachably coupled to the fourth connector configured to allow interchangeability of the sensor module with another sensor module that is configured to detect a second condition that is different from the first condition. The controller comprises a memory. The controller is configured to communicate with said another communication device to retrieve information from said another communication device and to store the information in the memory in response to determining that the communication device is interchanged with said another communication device. The network device comprises a fourth connector exposed from the enclosure and the sensor module further comprises a fifth connector detachably coupled to the fourth connector to allow interchangeability of the sensor module with another sensor module that is configured to detect a second condition that is different from the first condition. At least one of the network devices is an in-wall modular assembly comprising a mounting bracket configured to attach to an electrical box that is mounted in a house. The mounting bracket is configured to electrically connect to the first connector.

Certain embodiments relate to a method to receive and transmit data and commands over a network. The method comprises receiving, with a first connector of a first network device, electrical power, supplying power to the first network device, receiving, with a communication module of the first network device that uses a first communication protocol, coded messages from a second network device, the communication module configured to detachably couple from the first network device to allow the communication module to be interchanged with another communication module that uses a second communication protocol that is different from the first communication protocol, processing the coded messages to provide control signals, controlling operations of the first network device in response to the control signals and transmitting, with the communication module, the coded messages to a third network device over the home network.

In an embodiment, the method further comprises receiving the coded messages from and transmitting the coded messages to the second network device using powerline signaling. Each of the first and the second communication protocols include at least one of a home automation protocol, a mesh network protocol, an RF protocol, Bluetooth, a near-field communication protocol, Wi-Fi, a 4G LTE protocol and a 5G wireless protocol. The method further comprises determining whether the communication module is interchanged with said another communication module, retrieving information from said another communication module in response to the determination and storing the information in a memory of the first network device.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 is a block diagram of a communication network with devices using powerline, RF signaling, and light modulation signaling, according to certain embodiments.

FIG. 2 is a block diagram of an LED illumination module with powerline, RF, and light modulation signaling capabilities, according to certain embodiments.

FIG. 3 is a block diagram illustrating message retransmission within the communication network, according to certain embodiments.

FIG. 4A illustrates a process to receive messages within the communication network, according to certain embodiments.

FIG. 4B illustrates a process to retransmit messages within the communication network, according to certain embodiments.

FIG. 4C illustrates a process to determine by which transmission medium to retransmit messages based on network traffic, according to certain embodiments.

FIG. 5 illustrates a process to transmit messages to groups of devices within the communication network, according to certain embodiments.

FIG. 6 illustrates a process to transmit direct messages with retries to devices within the communication network, according to certain embodiments.

FIG. 7 is a block diagram of an LED illumination device illustrating the overall flow of information related to sending and receiving messages, according to certain embodiments.

FIG. 8 is a block diagram illustrating the overall flow of information related to transmitting messages on the powerline, according to certain embodiments.

FIG. 9 is a block diagram illustrating the overall flow of information related to receiving messages from the powerline, according to certain embodiments.

FIG. 10 illustrates a powerline BPSK signal, according to certain embodiments.

FIG. 11 illustrates a powerline BPSK signal with transition smoothing, according to certain embodiments.

FIG. 12 illustrates powerline signaling applied to the powerline, according to certain embodiments.

FIG. 13 illustrates standard message packets applied to the powerline, according to certain embodiments.

FIG. 14 illustrates extended message packets applied to the powerline, according to certain embodiments.

FIG. 15 is a block diagram illustrating the overall flow of information related to transmitting messages via RF, according to certain embodiments.

FIG. 16 is a block diagram illustrating the overall flow of information related to receiving messages via RF, according to certain embodiments.

FIG. 17 is a table of exemplary specifications for RF signaling within the communication network, according to certain embodiments.

FIG. 18 is a block diagram illustrating the overall flow of information related to transmitting messages via modulation of light from an LED illumination device, according to certain embodiments.

FIG. 19 is a block diagram illustrating the overall flow of information related to receiving messages via modulation of light from an LED illumination device, according to certain embodiments.

FIGS. 20A and 20B are an exemplary schematic diagram of an LED illumination device capable of transmitting and receiving messages over the communication network via powerline signaling, RF, and modulation of light, according to certain embodiments.

FIG. 21 illustrates an illumination device capable of transmitting and receiving messages over the communication network via powerline signaling, RF, and modulation of light, according to certain embodiments.

FIG. 22 is an exploded view of an in-wall system according to certain embodiments.

FIGS. 23-34 illustrate exemplary user interfaces, load control modules, and mounting brackets for an in-wall system, according to certain embodiments.

FIG. 35-37 are block diagrams illustrating a modular device with interchangeable communication modules, according to certain embodiments.

### DETAILED DESCRIPTION

The features of the systems and methods will now be described with reference to the drawings summarized above. Throughout the drawings, reference numbers are re-used to indicate correspondence between referenced elements. The drawings, associated descriptions, and specific implementation are provided to illustrate embodiments of the inventions and not to limit the scope of the disclosure.

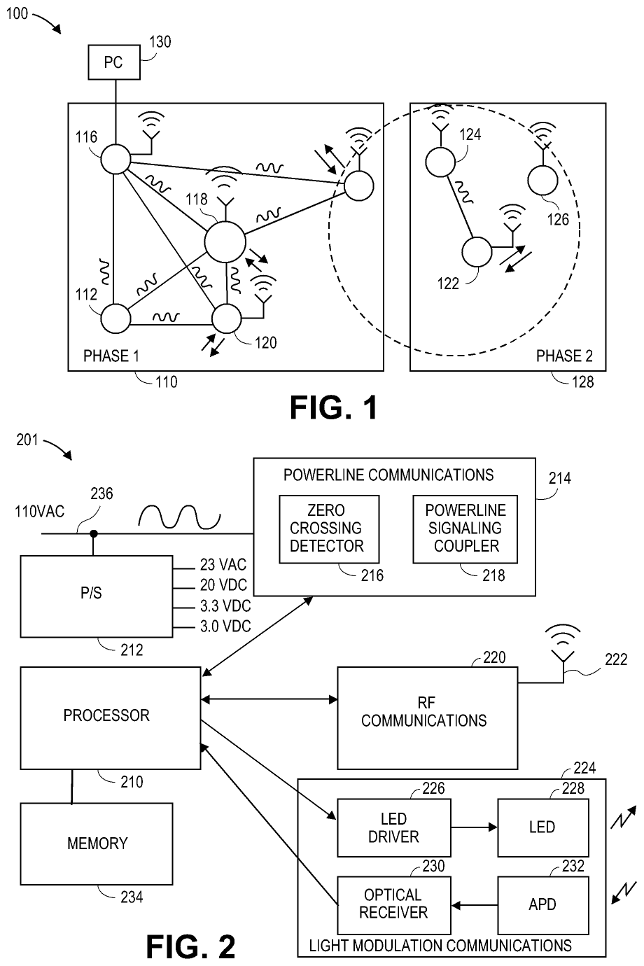

FIG. 1 is a block diagram of a communication network 100 of control and communication devices 112-126 communicating over the communication network 100 using one or more of powerline signaling, RF signaling, and light modulation signaling. The communication network 100 further comprises the local receiver (not illustrated) communicating over the communication network 100 using the RF signaling. The communication network 100 further comprises the local controller (not illustrated) communicating over the communication network. In an embodiment, the communication network 100 comprises a mesh network. In another embodiment, the communication network 100 comprises a simulcast mesh network. In a further embodiment, the communication network comprises a mesh network including a powerline network, and light modulation network. In a further embodiment, the communication network 100 comprises an INSTEON® network.

Electrical power is most commonly distributed to buildings and homes in North America as two-phase 220-volt alternating current (220 VAC). At the main junction box to the building, the three-wire 220 VAC power line is split into two two-wire 110 VAC power lines, known as Phase 1 and Phase 2. Phase 1 wiring is typically used for half the circuits in the building, and Phase 2 is used for the other half. In the exemplary network 100, devices 112, 114, 116, 118, 120 are connected to a Phase 1 power line 110 and devices 122, 124, 126, are connected to a Phase 2 power line 128.

In network 100, device 112 is configured to communicate over the power line; device 126 is configured to communicate via RF; and devices 116 and 124 are configured to communicate over the powerline and via RF. Additionally device 116 can be configured to communicate to a computer 130 and other digital equipment using, for example, RS232, USB, IEEE 802.3, or Ethernet protocols and communication hardware. Device 116 on the network 100 communicating with computer 130 and other digital devices can, for example, bridge to networks of otherwise incompatible devices in a building, connect to computers, act as nodes on a local-area network (LAN), or connect with the global Internet. Further, a Hub (not illustrated) between the computer 130 and the device 116 on the network 100 communicating with the computer 130 and other digital devices can, for example, bridge to networks of otherwise incompatible devices in a building, connect to computers, act as nodes on a local-area network (LAN), or connect with the global Internet. In an embodiment, the computer 130 comprises a personal computer, a laptop, a tablet, a smartphone, or the like, and interfaces with a user.

Further, the hub can be configured to receive messages containing data from a local controller (not illustrated) via the local receiver and the network 100. The hub can further be configured to provide information to a user through the computer 130, and can be configured to provide data and/or commands to the local controller via the local receiver and the network 100.

Devices 114, 118, 120, 122 comprise light emitting diode (LED) lighting devices and are configured to communicate over the power line, via RF, and using modulated light techniques.

In an embodiment, devices, such as devices 112, 114, 116, 118, 120, 122, 124 that send and receive messages over the power line, use the Insteon® Powerline protocol, and devices, such as devices 114, 116, 118, 120, 122, 124, 126 that send and receive radio frequency (RF) messages, use the Insteon® RF protocol, as defined in U.S. Pat. Nos. 7,345,998 and 8,081649 which are hereby incorporated by reference herein in their entireties. INSTEON® is a trademark of the applicant.

Devices 112-126 that use multiple media or layers solve a significant problem experienced by devices that only communicate via the powerline, such as device 112, or by devices that only communicate via RF, such as device 126. Powerline signals on opposite powerline phases 110 and 128 are severely attenuated because there is no direct circuit connection for them to travel over. RF barriers can prevent direct RF communication between devices RF only devices. Using devices capable of communicating over two or more of the communication layers solves the powerline phase coupling problem whenever such devices are connected on opposite powerline phases and solves problems with RF barriers between RF devices. Thus, within the network 100, the powerline layer assists the RF layer, and the RF layer assists the powerline layer.

Further, the illumination device is one example of the devices 112-126. LED lighting devices 114, 118, 120, 122 can send messages using modulation of the light emitted from the devices' LED and received modulated light encoded messages.

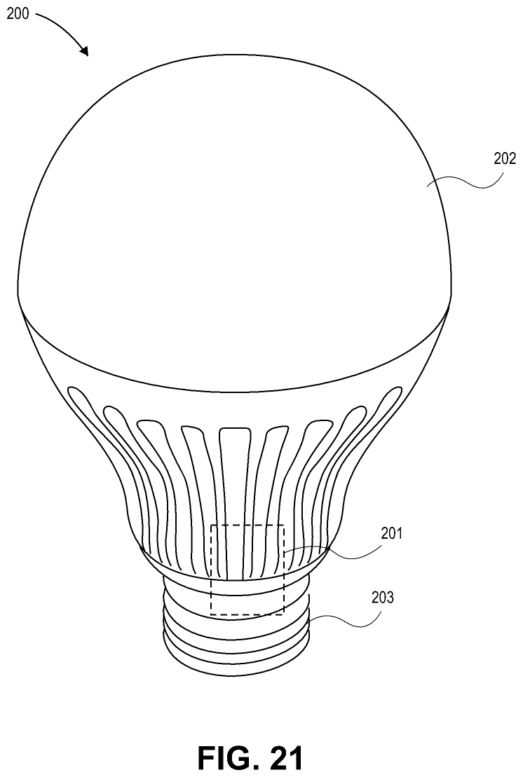

FIG. 21 illustrates an illumination device 200, such as an LED illumination device or module, and incandescent illumination device, a fluorescent illumination device, and the like. The illumination device 200 comprises an enclosure including a bulb 202 and a base 203. In an embodiment, the bulb 202 comprises glass, plastic, or other transparent or translucent material capable of emitting light waves from an illumination source, such as an LED array, a filament, or the like, within the enclosure. The base 203 attaches to the bulb and to a power source used to power the illumination source. For example, the bulb 203 can comprise threads for screwing the bulb into a standard light bulb socket electrically connected to 110-120 VAC house wiring.

The illumination device 200 further comprises electrical circuitry 201 disposed with the enclosure, as indicated by the dashed box. In an embodiment, the electrical circuitry 201 is configured to receive coded messages, process coded messages, and transmit coded messages. In another embodiment, the electrical circuitry 201 comprises at least one of receiving circuitry, processing circuitry, and transmitting circuitry. In a further embodiment, the electrical circuitry 201 comprises at least one of power line circuitry, radio frequency circuitry, and light wave modulation/demodulation circuitry.

FIG. 2 is a block diagram of the electrical circuitry 201 disposed within the enclosure of the illumination device 200 comprising powerline (PL), RF, and light modulation signaling capabilities. The electrical circuitry 201 comprises a processor 210, a power supply 212, powerline communication circuitry 214, RF communication circuitry 220, and light modulation circuitry 224.

### Power Supply

The power supply 212 receives a 110 VAC power signal over the power line 236 and generates one or more voltages, such as 20 VDC, 3.3 VDC, 3.0 VDC, for example, to power the circuitry 210, 214, 220, 224. In other embodiments, the power supply 212 converts the line voltage to other direct current voltage and transforms the line voltage to other alternating current voltages as need by the accompanying circuitry 210, 214, 220, 224, . In an embodiment, the power supply components comprise a high efficiency mains or power line voltage to communications drive and logic level voltages via a buck regulator two-stage supply. In an embodiment, the power supply 212 uses full wave rectification to take advantage of the energy of both the positive and negative portions of the AC supply.

### Processor

The processor circuitry 210 provides program logic and memory 234 in support of programs and intelligence within the LED lighting device 200, as well as bulb functions, such as dimming, ON, and OFF. The program logic may advantageously be implemented as one or more modules. The modules may advantageously be configured to execute on one or more processors. The modules may comprise, but are not limited to, any of the following: software or hardware components such as software object-oriented software components, class components and task components, processes methods, functions, attributes, procedures, subroutines, segments of program code, drivers, firmware, microcode, circuitry, data, databases, data structures, tables, arrays, or variables.

In an embodiment, the processor circuitry 220 comprises a computer and associated memory. The computers comprise, by way of example, processors, program logic, or other substrate configurations representing data and instructions, which operate as described herein. In other embodiments, the processors can comprise controller circuitry, processor circuitry, processors, general purpose single-chip or multi-chip microprocessors, digital signal processors, embedded microprocessors, microcontrollers and the like. The memory 234 can comprise one or more logical and/or physical data storage systems for storing data and applications used by the processor 220 and the program logic.

In an embodiment, programming may include day-light harvesting, local device timers, macros, and automatic LED brightness control to prevent damage to the LEDs if ambient temperature conditions put them at risk. In an embodiment, the LED lighting module 200 comprises internal temperature sensing that can be used as a network-based remote temperature sensor when device-generated heat is taken into account.

In other embodiments, the programming may include processes to determine whether to simultaneous transmit or retransmit messages over the powerline, via RF and using light modulation, or to determine a preferred one of the powerline, RF and light modulation physical layers for message transmission/retransmission. In a further embodiment, the programming may a process to determine from which physical layer the majority of message traffic is on, and to determine which physical layer (PL, RF, light modulation) to transmit/retransmit messages to increase message reception by the intended recipient device.

### Powerline (PL) Communications

The LED lighting module 200 can use binary phase-shift keying (BPSK) networking to communicate to other devices over the power line. In another embodiment, the LED lighting module 200 can use binary phase-shift keying (BPSK) simulcast mesh networking to communicate to other devices over the power line.

In other embodiments, other encoding schemes, such as return to zero (RZ), Nonreturn to Zero-Level (NRZ-L), Nonreturn to Zero Inverted (NRZI), Bipolar Alternate Mark Inversion (AMI), Pseudoternary, differential Manchester, Amplitude Shift Keying (ASK), Phase Shift Keying (PSK), and the like, could be used.

The powerline communication circuitry comprises a zero crossing detector 216 and a powerline signaling coupler 218. The zero crossing detector 216 can determine when the alternating current line voltage waveform is at a zero crossing. The powerline signaling coupler 218 can encode a message using BPSK onto a carrier signal or decode a BPSK message from the carrier signal based at least in part on the timing provided by the zero crossing detector 216.

To transmit a powerline message, the processor 210 can send the message data to the powerline coupling circuitry 218 which encodes the data using BPSK onto a carrier signal which is sent over a portion of the powerline signal at the appropriate time as determined by the zero crossing detector 216. To receive a powerline message, the powerline coupling circuitry 218 can receive the BPSK data encoded powerline signal from the power line 236. The powerline signaling coupler 218 can decode the BPSK data from the carrier signal based at least in part on the timing provided by the zero crossing detector 216. The powerline signaling coupler 218 can send the data to the processor 210 for processing.

In an embodiment the carrier signal frequency is preferably approximately 131.65 KHz. In another embodiment, the carrier signal frequency can be between approximately 120 KHz and approximately 140 KHz. In a further embodiment, the carrier signal frequency can be approximately 110 KHz to approximately 150 KHz. In a yet further embodiment, the carrier signal frequency can be approximately 100 KHZ to approximately 120 KHz. In other embodiments the carrier signal frequency can be less than 100 KHz. In further embodiments, the carrier signal frequency can be greater than 200 KHz.

The power line communications work well in environments where RF and light modulation communications fail. In an embodiment, the powerline signaling coupler 218 can provide an inexpensive tie to the line voltage, while the zero-crossing detection circuit 216 can provide an over-all network synchronization to the AC mains.

### Radio Frequency (RF) Communications

The RF communications circuit 220 can use narrow band frequency shift keying (FSK) communications. The processor 210 can send message data to the RF communications circuitry 220, where the data is encoded using FSK onto a baseband signal, which is up converted and transmitted from antenna 222 to other devices on the network 100. In addition, the antenna 222 can receive RF signals which are down converted to a baseband FSK encoded signal and decoded by the RF communications circuitry 220. The processor circuitry 210 can receive the decoded message data and process the message.

### Light Modulation Communications

The light modulation communication circuitry 224 comprises a visible light transceiver and includes LED driver circuitry 226 and one or more LEDs 228 configured to transmit messages optically. The modulation circuitry 224 further includes an optical sensor 232 and optical receiver circuitry 230 configured to receive messages optically. The drive circuit 226 and the LEDs 228 can have very fast ON/OFF switching times allowing for pulse-width modulation (PWM) control or other modulation techniques. In an embodiment, continuous mains power can enable the pulse width modulation output to the LEDs 228 as a constant current source.

Dimmable control of the LED illumination device 200 may be accomplished using medium and high frequency pulse width modulation. Modulation control can be adjusted by the processor circuitry 220 to send messages without interrupting the illumination mission. Because dimming can be actuated via commands, a message may contain a specific digital level and ramp or fade rate that is highly consistent from LED illumination device to the next.

To transmit a light modulated message, the processor 220 can send message data to the LED driver circuitry 226 to drive the LEDs 228 to produce modulated light encoding the message. To receive light modulated messages, the modulated light can be received by the optical sensor 232, such as an avalanche photodiode. The resulting electrical signal can be received by the optical receiver 230 which decodes the message from the electrical signal and sends the message to the processor 220 for processing.

In an embodiment, the light modulation circuitry 224 can use the same encoding protocol, such as BPSK, for example, and the same carrier signal as the powerline signaling described above. In an embodiment, the timing and the signaling for the light modulation communications may be the same as that used for the powerline communications. Advantageously, the BPSK signaling and bit transitions at the carrier signal frequency described above with respect to the powerline communications do not cause visually detectable flicker in the LED light output. Further, such encoded messages can support pulse width modulation (PWM) dimming as well as embedding phase shift data.

In an embodiment, messages may be sent between LED lighting devices 200 when bulb operation includes modulation pauses in output for message reception. In another embodiment, messages may be sent between LED lighting devices 200 simultaneously by using alternate light sensors 232.

In another embodiment, the messages can be encoded using binary phase shift keying (BPSK) on an approximately 131.65 KHz carrier signal modulated onto the light from the LEDs. In an embodiment, the light modulation circuitry 224 can use the same encoding protocol, such as BPSK, for example, and the same carrier signal as the powerline signaling described above. In an embodiment, the timing and the signaling for the light modulation communications may be the same as that used for the powerline communications. Advantageously, the BPSK signaling and bit transitions at the carrier signal frequency described above with respect to the powerline communications do not cause visually detectable flicker in the LED light output. Further, such encoded messages can support pulse width modulation (PWM) dimming as well as embedding phase shift data.

In an embodiment, the LED lighting device 200 can replace conventional illumination sources such as a common screw-in type light bulb. LED lighting devices 200 can provide lighting solutions over a range of different form factors and particularly with those that include metal housings surrounding most of a bulb which results in shielding RF communications. This is particularly common in recessed ceiling light fixtures. Form factors such as A19, standard screw-in type incandescent light bulb, a fluorescent tube, or other common replaceable illumination elements can be used. Examples of other form factors are the A series, the B series, the C-7/F series, the G series, the P-25/ps-35 series, the BR series, the R series, the RP-11/S series, the Par series, the T series, and the like.

A user can turn on specific LED lighting devices 200 helpful for some activities in a room or area while not intruding on other activities. For instance, one portion of a room may have lights that are dimmed while another portion of the room may have lights that are at a higher level of output. Individual light bulb control is beneficial for accent lighting such as for art objects, or for up-lighting artistic effects.

In an embodiment, the LED illumination module 200 comprises a simulcast mesh dimmable Insteon® illumination source which is referred to using the term “Insteon bulb” which uses Insteon® technology as defined in U.S. Pat. Nos. 7,345,998 and 8,081,649 which are hereby incorporated by reference herein in their entireties. The Insteon bulb can propagate messages using wireless radio frequency broadcasting, power wiring conduction, and relatively high frequency pulse width modulated visible light. The precise control in brightness that is possible with an LED can enable a light output (illumination) to be used as a communication source that is hidden within the visible illuminating light output itself. The Insteon bulb can use power lines and radio frequency transmission to send and receive messages efficiently to all other Insteon bulbs simultaneously or approximately simultaneously.

The communication network 100 may function using radio communications only, power line communications only, light modulation communications only, any two simultaneously, all three simultaneously, in a sequence of two or more, or in an intelligently determined hierarchy. This creates a significant advantage, in that, alone, one transmission medium may fail to meet a particular objective while simulcasting over two or more media may succeed.

Referring to FIG. 1, devices 114-124 that use two or more of the powerline, RF, and modulation communication media or layers can solve a significant problem experienced by devices that only communicate via the powerline, such as device 112. Powerline signals on opposite powerline phases 110 and 128 can be severely attenuated because there is no direct circuit connection for them to travel over. Using devices capable of communicating over two or more of the communication layers can solve the powerline phase coupling problem whenever such devices are connected on opposite powerline phases.

As shown in FIG. 1, device 114 is installed on powerline phase 1 110 and device 124 is installed on powerline phase 2 128. Device 114 can communicate via power line with devices 116, 118 on powerline phase 1 110, but it can also communicate via power line with device 124 on powerline phase 2 128 because it can communicate using RF signaling or light modulation with device 122, which in turn is directly connected to powerline phase 2 128. The dashed circle represents the RF range of device 122. Direct RF paths between devices 114 to 124 (1 hop), or indirect paths using 122 and 124 (2 hops) can allow messages to propagate between the powerline phases.

Each device 112-126 can be configured to repeat messages to others of the devices 112-126 on the network 100. In an embodiment, each device 112-126 can be capable of repeating messages, using the protocols as described herein. Further, the devices 112-126 can be peers, meaning that any device can act as a master (sending messages), slave (receiving messages), or repeater (relaying messages). Adding more devices configured to communicate over more than one physical layer can increase the number of available pathways for messages to travel. Path diversity results in a higher probability that a message will arrive at its intended destination.

For example, RF device 120 desires to send a message to device 114, but device 114 is out of range. The message will still get through, however, because devices within range of device 120, such as devices 112, 116, 118 can receive the message and repeat it to other devices within their respective ranges. There are many ways for a message to travel: device 120 to 118 to 114 (2 hops), device 120 to 112 to 118 to 114 (3 hops), device 120 to 116 to 112 to 1118 to 114 (4 hops) are some examples.

Unless there is a limit on the number of hops that a message may take to reach its final destination, messages might propagate forever within the network 100 in a nested series of recurring loops. Network saturation by repeating messages is known as a “data storm.” The message protocol can avoid this problem by limiting the maximum number of hops an individual message may take to some small number, such as, for example, four. In other embodiments, the number of hops can be limited to less than 4. In other embodiments, the number of hops can be limited to a number greater than 4 and less than 10. The larger the number of retransmissions, however, the longer the message will take to complete.

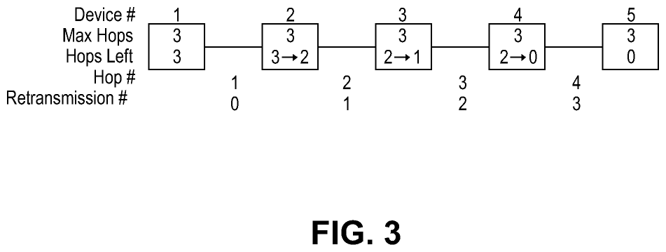

FIG. 3 is a block diagram illustrating message retransmission within the communication network 100. In order to improve network reliability, the LED lighting devices 200 can retransmit messages intended for other devices on the network 100. This can increase the range that the message can travel to reach its intended device recipient.

However, to avoid endless repetition data storms, in an embodiment, messages can be retransmitted a maximum of three times. In other embodiments, the number of times a message can be retransmitted is less than 3. In further embodiments, the number of times a message can be retransmitted is greater than 3. The larger the number of retransmissions, however, the longer the message will take to complete.

Embodiments comprise a pattern of transmissions, retransmissions, and acknowledgements that occurs when messages are sent. Message fields, such as Max Hops and Hops Left can manage message retransmission. In an embodiment, messages can originate with the 2-bit Max Hops field set to a value of 0, 1, 2, or 3, and the 2-bit Hops Left field set to the same value. A Max Hops value of zero can tell other devices within range not to retransmit the message. A higher Max Hops value can tell devices receiving the message to retransmit it depending on the Hops Left field. If the Hops Left value is one or more, the receiving device can decrement the Hops Left value by one, then retransmit the message with the new Hops Left value. Devices 200 that receive a message with a Hops Left value of zero will not retransmit that message. Also, a device 200 that is the intended recipient of a message will not retransmit the message, regardless of the Hops Left value.

In other words, Max Hops is the maximum retransmissions allowed. All messages “hop” at least once, so the value in the Max Hops field can be one less than the number of times a message actually hops from one device to another. In embodiments where the maximum value in this field is three, there can be four actual hops, comprising the original transmission and three retransmissions. Four hops can span a chain of five devices. This situation is shown schematically in FIG. 3.

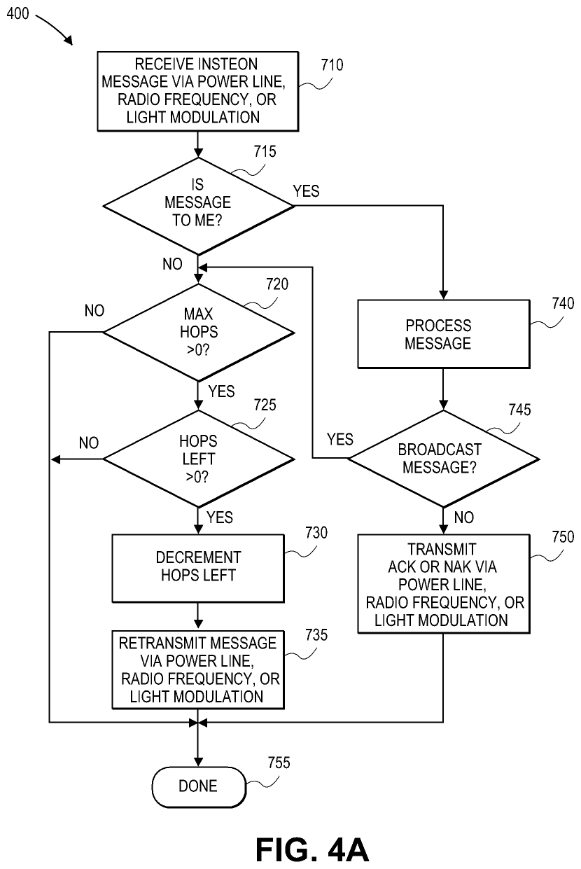

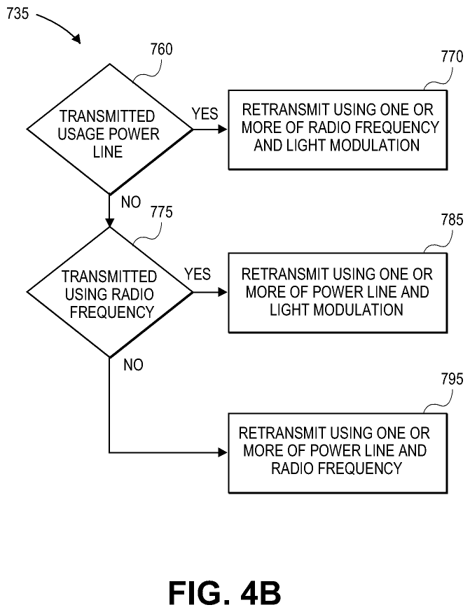

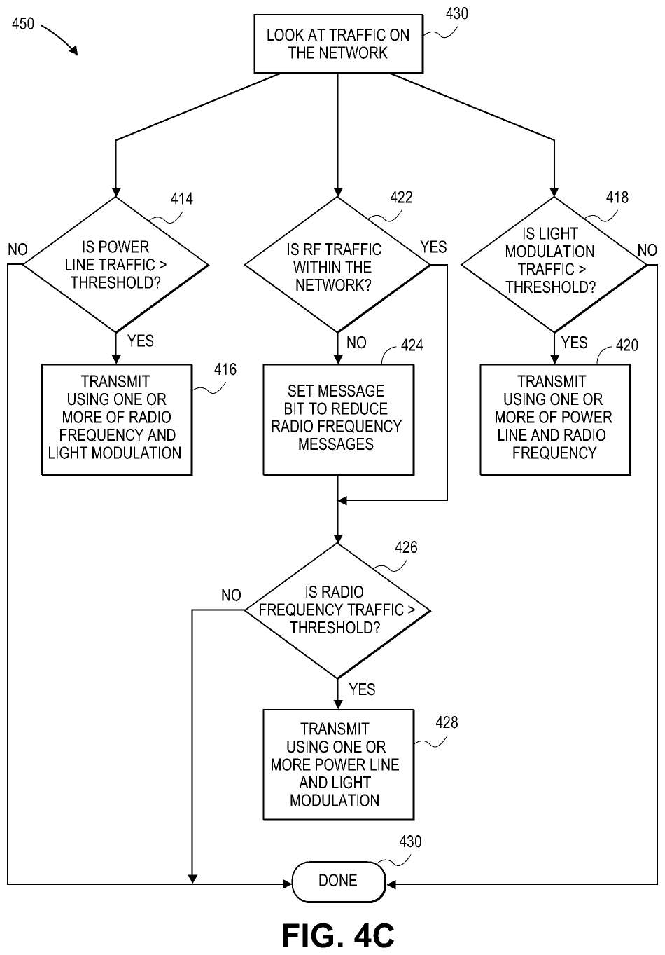

FIG. 4A illustrates a process 400 to receive messages within the communication network 100. The flowchart in FIG. 4A shows how the LED device 200 can receive messages and determine whether to retransmit them or process them. At step 710, the device 200 can receive a message via powerline, RF or light modulation.

At step 715, the process 400 can determine whether the device 200 needs to process the received message. The device 200 can process Direct messages when the device 200 is the addressee, Group Broadcast messages when the device 200 is a member of the group, and all Broadcast messages.

If the received message is a Direct message intended for the device 200, a Group Broadcast message where the device 200 is a group member, or a Broadcast message, then the process 400 moves to step 740. At step 740, the device 200 can process the received message.

At step 745, the process 400 can determine whether the received message is a Group Broadcast message or one of a Direct message and Direct group-cleanup message. If the message is a Direct or Direct Group-cleanup message, the process moves to step 750. At step 750, the device 200 can send an acknowledge (ACK) or a negative acknowledge (NAK) message back to the message originator in step 750 and end the task at step 755.

In an embodiment, the process 400 can simultaneously or approximately simultaneously send the ACK/NAK message over the powerline, via RF, and via light modulation. In another embodiment, the process 400 can send the ACK/NAK message over the powerline, via RF, and via light modulation. In another embodiment, the process 400 can intelligently select which physical layer (power line, RF, light modulation) to use for ACK/NAK message transmission. In a further embodiment, the process 400 can sequentially send the ACK/NAK message using a different physical layer for each subsequent retransmission.

If at step 745, the process 400 determines that the message is a Broadcast or Group Broadcast message, the process 400 can move to step 720. If, at step 715, the process 400 determines that the device 200 does not need to process the received message, the process 400 can also move to step 720. At step 720, the process 400 can determine whether the message should be retransmitted.

At step 720, the Max Hops bit field of the Message Flags byte can be tested. If the Max Hops value is zero, process 400 can move to step 755, where it ends. If the Max Hops filed is not zero, the process 400 can move to step 725, where the Hops Left filed can be tested.

If there are zero Hops Left, the process 400 can move to step 755, where it ends. If the Hops Left field in not zero, the process 400 can move to step 730, where the process 400 can decrement the Hops Left value by one.

At step 735, the process 400 can retransmit the message. In an embodiment, the process 400 can simultaneously or approximately simultaneously retransmit the message over the power line, via RF, and via light modulation. In another embodiment, the process 400 can retransmit the message over the power line, via RF, and via light modulation. In another embodiment, the process 400 can intelligently select which physical layer (PL, RF, light modulation) to use for message retransmission. In a further embodiment, the process 400 can sequentially retransmit the message using a different physical layer for each subsequent retransmission.

FIG. 4B illustrates an embodiment of the process 400 at step 735 to retransmit messages within the communication network 100 using transmission media in any order.

At step 760, the process 735 can determine if the message was transmitted using powerline communications. If the message had previously been transmitted over the power line, at step 770, the process 400 can retransmit the message using one or more of radio frequency signaling and light modulation signaling.

If the message had not been previously transmitted over the power line, the process 735 can check whether the message had previously been transmitted using radio frequency and/or light modulation signaling. At step 775, the process 735 determines if the message was transmitted using radio frequency communications. At step 785, if the message had previously been transmitted using radio frequency communications, the process 735 can retransmit the message using one or more of powerline signaling and light modulation signaling.

At step 795, if the message had previously been transmitted using neither powerline signaling nor radio frequency signaling, the process 735 can retransmit the message using one or more of radio frequency signaling and light modulation signaling.

Thus, the process 735 sequences through hierarchies of the communication media. In an embodiment, this could be implemented using a message bit representing a Media Counter to sequence through the physical layers used to send a transmission. Different logic could be used to determine which combinations of media are used to retransmit the message.

FIG. 4C illustrates a process 450 to determine which transmission medium to retransmit messages based at least in part on network traffic. If the traffic on a particular physical layer is too great, messages on that physical layer will be delayed. Instead of retransmitting the message simultaneously on all of the physical layers, including the layer with too much traffic, the LED illumination device 200 can transmit or retransmit the message using the others of the physical layers.

Further, in high density living areas, such as multi-dwelling units, the RF signals may propagate beyond the boundaries of the dwelling. Such situations may limit the number of radio frequency retransmissions and the LED illumination unit 200 intelligently forces the use of radio frequency and light modulation signaling.

Referring to FIG. 4C, at step 410, the process 450 can look at the message traffic on the communication network 100. At step 414, the powerline traffic can be compared to a powerline traffic threshold. If the amount of message traffic on the network on the power line layer is greater than the threshold, the process 400 can transmit or retransmit the message using one or more of RF signaling and light modulation signaling at step 416. If the threshold is not met, the process 450 finishes at step 430.

At step 418, the light modulation traffic can be compared to a light modulation traffic threshold. If the amount of light modulation message traffic on the network is greater than the threshold, the process 450 can transmit or retransmit the message using one or more of RF signaling and PL signaling at step 420. If the light modulation threshold is not met, the process 400 finishes at step 430.

At step 422, the process 450 can determine if the majority of radio frequency message traffic is from devices with the network 100. In an embodiment, the process 400 can determine whether majority of radio frequency message traffic is from devices with the network by comparing device addresses to a list of network device addresses.

If the radio frequency message traffic is from devices outside the network 100, then the LED devices 200 may also be transmitting to devices 200 outside of the network 100. At step 424, the process 450 reduces the number of messages transmitted using radio frequency signaling. In an embodiment, the process 450 sets a bit in the message data to reduce or stop radio frequency messaging.

If the majority of radio frequency message traffic is from devices within the network 100, the process 450 can move to step 426. At step 426, the radio frequency traffic can be compared to a radio frequency traffic threshold. If the amount of radio frequency message traffic on the network is greater than the radio frequency traffic threshold, the process 450 can transmit or retransmit the message using one or more of powerline signaling and light modulation signaling at step 428. If the radio frequency traffic threshold is not met, the process 450 finishes at step 430.

Thus, variations in the logic above could produce different signaling orders based on message traffic criteria. For example, if the threshold is exceeded for powerline traffic, the process could transmit the coded messages only via light modulation. If the threshold is exceeded for radio frequency traffic, the process 450 could transmit the coded messages only via power line. All permutations of power line, radio frequency, and light wave modulation signaling are possible.

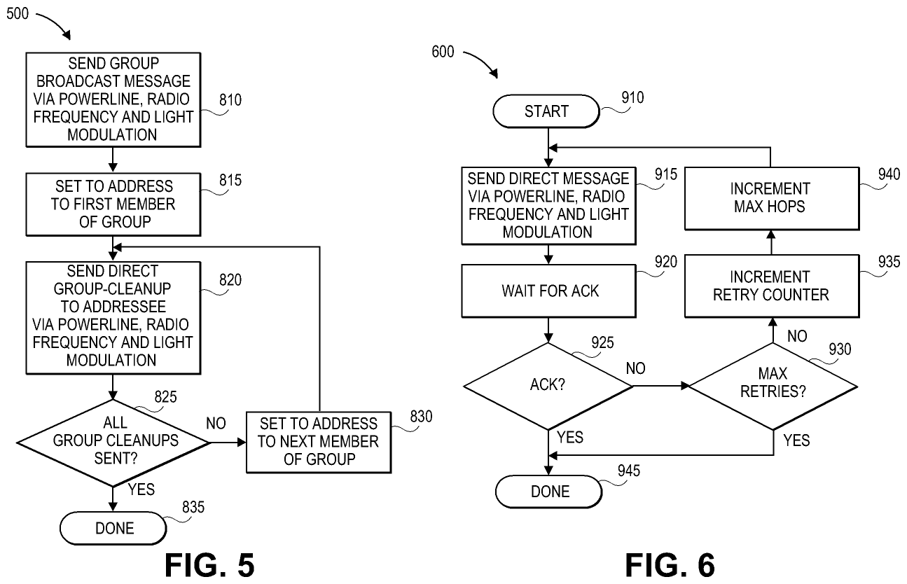

FIG. 5 illustrates a process 500 to transmit messages to multiple recipient devices in a group within the communication network 100. Group membership can be stored in a database in the device 200 following a previous enrollment process. At step 810, the device 200 can first send a Group Broadcast message intended for all members of a given group. The Message Type field in the Message Flags byte can be set to signify a Group Broadcast message, and the To Address field can be set to the group number, which can range from 0 to 255. The device 200 can transmit the message using at least one of powerline, radio frequency, and light modulation. In an embodiment, the device 200 can transmit the message using all of powerline, radio frequency, and light modulation.

Following the Group Broadcast message, the transmitting device 200 can send a Direct Group-cleanup message individually to each member of the group in its database. At step 815 the device 200 can first set the message To Address to that of the first member of the group, then it can send a Direct Group-cleanup message to that addressee at step 820. If Group-cleanup messages have been sent to every member of the group, as determined at step 825, transmission is finished at step 835. Otherwise, the device can set the message To Address to that of the next member of the group and sens the next Group-cleanup message to that addressee at step 820.

FIG. 6 illustrates a process 600 to transmit direct messages with retries to a device 200 within the communication network 100. Direct messages can be retried multiple times if an expected ACK is not received from the addressee. The process begins at step 910.

At step 915, the device 200 can send a Direct or a Direct Group-cleanup message to an addressee. At step 920 the device 200 can wait for an Acknowledge message from the addressee. If at step 925 an Acknowledge message is received and it contains an ACK with the expected status, the process is finished at step 945.

If at step 925 an Acknowledge message is not received, or if it is not satisfactory, a Retry Counter can be tested at step 930. If the maximum number of retries has already been attempted, the process fails at step 945. In an embodiment, devices 200 can default to a maximum number of retries of five. If fewer than five retries have been tried at step 930, the device 200 can increment its Retry Counter at step 935. At step 940, the device 200 will also increment the Max Hops field in the Message Flags byte, up to a maximum of three, in an attempt to achieve greater range for the message by retransmitting it more times by more devices. The message can be resent at step 915.

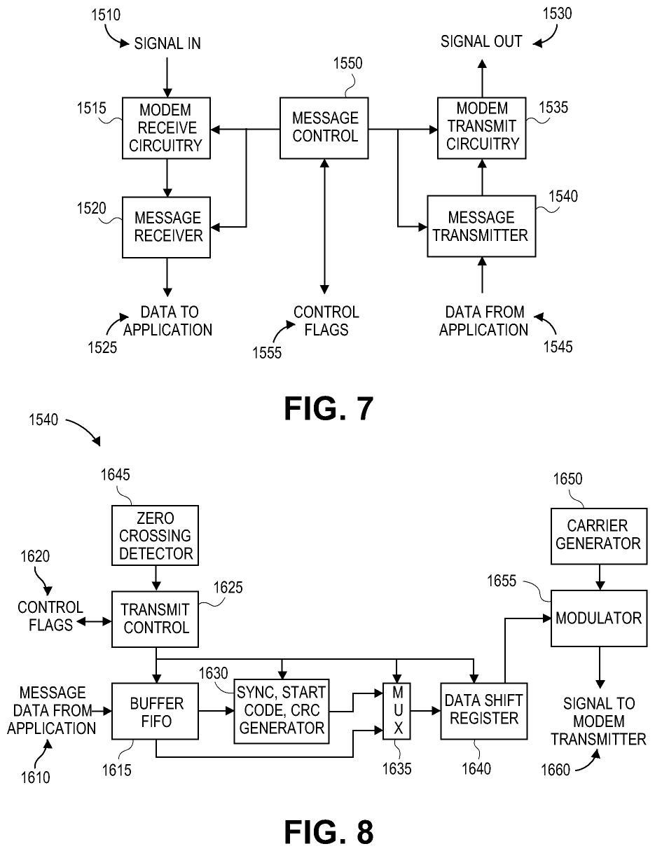

The devices 200 comprise hardware and firmware that enable the devices 200 to send and receive messages. FIG. 7 is a block diagram of the LED illumination device 200 illustrating the overall flow of information related to sending and receiving messages. Received signals 1510 can come from the powerline, via radio frequency, or via light modulation. Signal conditioning circuitry 1515 can process the raw signal and convert it into a digital bitstream. Message receiver firmware 1520 can process the bitstream as required and place the message payload data into a buffer 1525 which can be available to the application running on the device 200. The message controller 1550 can tell the application that data is available using control flags 1555.

To send a message, the application can place message data in a buffer 1545, then tell the message controller 1550 to send the message using control flags 1555. The message transmitter firmware 1540 can process the message into a raw bitstream, which it can feed to the transmitter section of the modem 1535. The modem transmitter can send the bitstream as a powerline, radio frequency signal, or light modulation signal 1530.

FIG. 8 shows message transmitter 1540 of FIG. 7 in greater detail and illustrates the device 200 sending a message on the powerline. The application can first compose a message 1610 to be sent, excluding the CRC byte, and put the message data in the transmit buffer 1615. The application can then tell the transmit controller 1625 to send the message by setting appropriate control flags 1620. The transmit controller 1625 can packetize the message data by using multiplexer 1635 to put sync bits and a start code from generator 1630 at the beginning of a packet followed by data shifted out of the first-in first-out (FIFO) transmit buffer 1615.

As the message data is shifted out of FIFO 1615, a cyclic redundancy check (CRC) generator 1630 can calculate the CRC byte, which is appended to the bitstream by multiplexer 1635 as the last byte in the last packet of the message. The bitstream can be buffered in a shift register 1640 and clocked out in phase with the powerline zero crossings detected by zero crossing detector 1645. The BPSK modulator 1655 can shift the phase of the 131.65 KHz carrier from carrier generator 1650 by 180 degrees for zero-bits, and leave the carrier unmodulated for one-bits. Note that the phase can be shifted gradually over one carrier period as disclosed in conjunction with FIG. 11. Finally, the modulated carrier signal can be applied to the powerline by the modem transmit circuitry 1535 of FIG. 7.

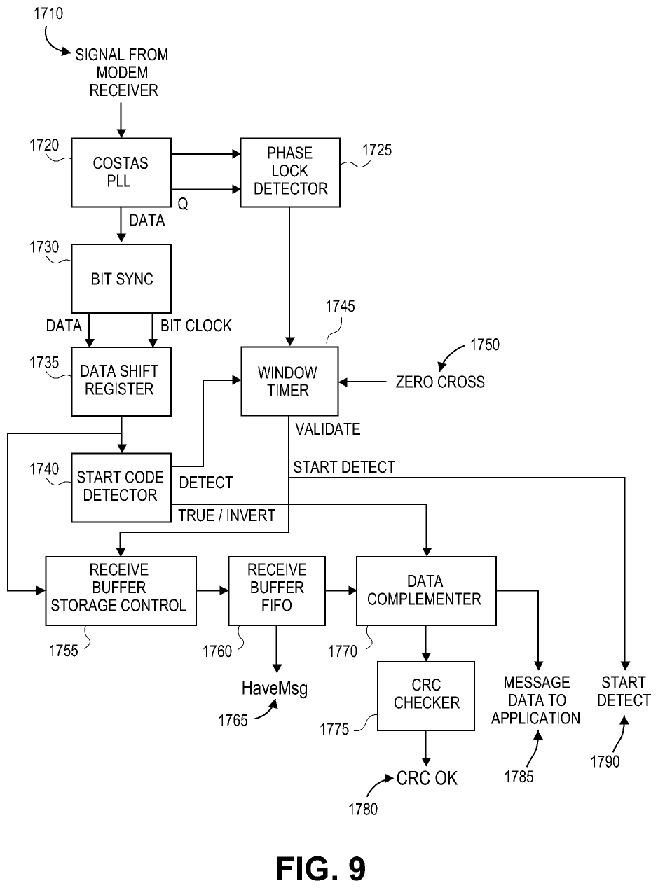

FIG. 9 shows message receiver 1520 of FIG. 7 in greater detail and illustrates the device 200 receiving a message from the powerline. The modem receive circuitry 1515 of FIG. 7 can condition the signal on the powerline and transform it into a digital data stream that the firmware in FIG. 9 processes to retrieve messages. Raw data 1710 from the powerline can be typically very noisy, because the received signal can have an amplitude as low as a only few millivolts, and the powerline often carries high-energy noise spikes or other noise of its own. Therefore, in a preferred embodiment, a Costas phase locked loop (PLL) 1720, implemented in firmware, can be used to find the BPSK signal within the noise. Costas PLLs, well known in the art, phase-lock to a signal both in phase and in quadrature. The phase-lock detector 1725 can provide one input to the window timer 1745, which also receives a zero crossing signal 1750 and an indication that a start code in a packet has been found by start code detector 1740.

Whether it is phase-locked or not, the Costas PLL 1720 can send data to the bit sync detector 1730. When the sync bits of alternating ones and zeros at the beginning of a packet arrive, the bit sync detector 1730 will be able to recover a bit clock, which it uses to shift data into data shift register 1735. The start code detector 1740 can look for the start code following the sync bits and output a detect signal to the window timer 1745 after it has found one. The window timer 1745 can determine that a valid packet is being received when the data stream begins approximately 800 microseconds before the powerline zero. The phase lock detector 1725 can indicate lock, and detector 1740 can find a valid start code. At that point the window timer 1745 can set a start detect flag 1790 and enable the receive buffer controller 1755 to begin accumulating packet data from shift register 1735 into the FIFO receive buffer 1760. The storage controller 1755 can insure that the FIFO 1760 builds up the data bytes in a message, and not sync bits or start codes. It can store the correct number of bytes, 10 for a standard message and 24 for an extended message, for example, by inspecting the Extended Message bit in the Message Flags byte. When the correct number of bytes has been accumulated, a HaveMsg flag 1765 can be set to indicate a message has been received.

Costas PLLs have a phase ambiguity of 180 degrees, since they can lock to a signal equally well in phase or anti-phase. Therefore, the detected data from PLL 920 may be inverted from its true sense. The start code detector 1740 can resolve the ambiguity by looking for the true start code, C3 hexadecimal, and also its complement, 3C hexadecimal. If it finds the complement, the PLL is locked in antiphase and the data bits are inverted. A signal from the start code detector 1740 tells the data complementer 1770 whether to un-invert the data or not. The CRC checker 1775 can compute a CRC on the received data and compare it to the CRC in the received message. If they match, the CRC OK flag 1780 can be set.

Data from the complementer 1770 can flow into an application buffer, not shown, via path 1785. The application will have received a valid message when the HaveMsg flag 1765 and the CRC OK flag 1780 are both set.

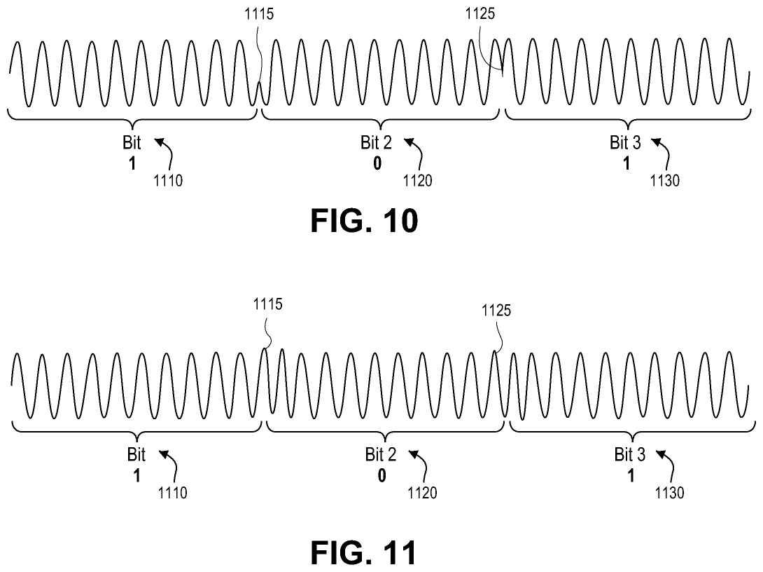

FIG. 10 illustrates an exemplary 131.65 KHz powerline carrier signal with alternating BPSK bit modulation. Each bit uses ten cycles of carrier. Bit 1110, interpreted as a one, begins with a positive-going carrier cycle. Bit 2 1120, interpreted as a zero, begins with a negative-going carrier cycle. Bit 3 1130, begins with a positive-going carrier cycle, so it is interpreted as a one. Note that the sense of the bit interpretations is arbitrary. That is, ones and zeros could be reversed as long as the interpretation is consistent. Phase transitions can only occur when a bitstream changes from a zero to a one or from a one to a zero. A one followed by another one, or a zero followed by another zero, will not cause a phase transition. This type of coding is known as NRZ, or nonreturn to zero.

FIG. 10 shows abrupt phase transitions of 180 degrees at the bit boundaries 1115 and 1125. Abrupt phase transitions can introduce troublesome high-frequency components into the signal's spectrum. Phase-locked detectors can have trouble tracking such a signal. To solve this problem, the powerline encoding process can use a gradual phase change to reduce the unwanted frequency components.

FIG. 11 illustrates the powerline BPSK signal of FIG. 10 with gradual phase shifting of the transitions. The transmitter can introduce the phase change by inserting 1.5 cycles of carrier at 1.5 times the 131.65 KHz frequency. Thus, in the time taken by one cycle of 131.65 KHz, three half-cycles of carrier will have occurred, so the phase of the carrier can be reversed at the end of the period due to the odd number of half-cycles. Note the smooth transitions 1115 and 1125.

In an embodiment, the powerline packets comprise 24 bits. Since a bit takes ten cycles of 131.65 KHz carrier, there are 240 cycles of carrier in a packet, meaning that a packet lasts 1.823 milliseconds. The powerline environment can be notorious for uncontrolled noise, especially high-amplitude spikes caused by motors, dimmers and compact fluorescent lighting. This noise can be minimal during the time that the current on the powerline reverses direction, a time known as the powerline zero crossing. Therefore, the packets can be transmitted near the zero crossing.

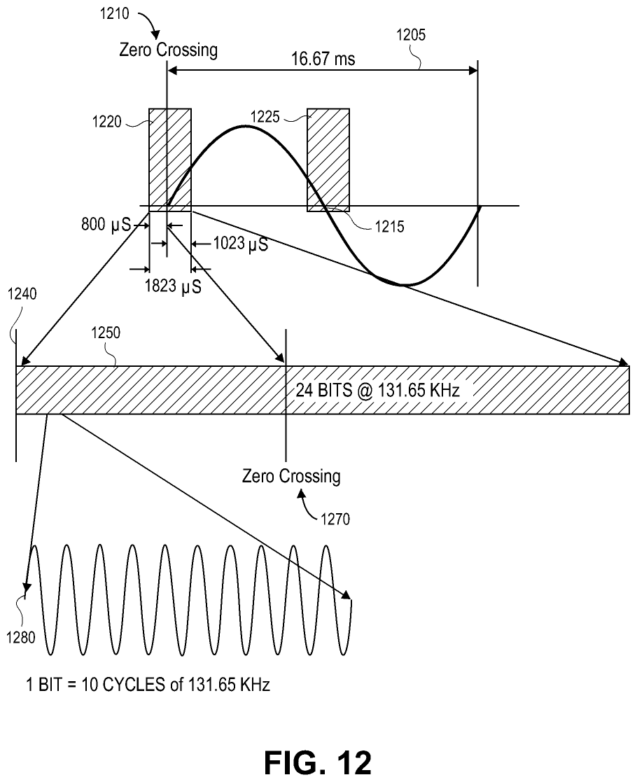

FIG. 12 illustrates powerline signaling applied to the power line. Powerline cycle 1205 possesses two zero crossings 1210 and 1215. A packet 1220 is at zero crossing 1210 and a second packet 1225 is at zero crossing 1215. In an embodiment, the packets 1210, 1215 begin 800 microseconds before a zero crossing and last until 1023 microseconds after the zero crossing.

In some embodiments, the powerline transmission process can wait for one or two additional zero crossings after sending a message to allow time for potential RF retransmission of the message by devices 200.

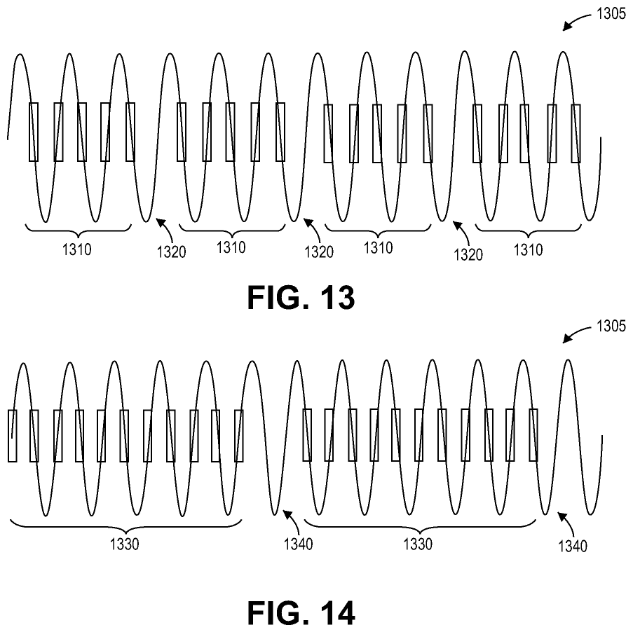

FIG. 13 illustrates an exemplary series of five-packet standard messages 1310 being sent on the powerline signal 1305. In an embodiment, the powerline transmission process can wait for at least one zero crossing 1320 after each standard packet before sending another packet. FIG. 14 illustrates an exemplary series of eleven-packet extended messages 1330 being sent on the powerline signal 1305. In another embodiment, the powerline transmission process can wait for at least two zero crossings 1340 after each extended packet before sending another packet. In other embodiments, the powerline transmission process does not wait for extra zero crossings before sending another packet.

In some embodiments, standard messages can contain 120 raw data bits and use six zero crossings, or 50 milliseconds to send. In some embodiments, extended messages can contain 264 raw data bits and use thirteen zero crossings, or 108.33 milliseconds to send. Therefore, the actual raw bitrate is 2,400 bits per second for standard messages, and 2,437 bits per second for extended messages, instead of the 2880 bits per second the bitrate would be without waiting for the extra zero crossings.

In some embodiments, standard messages can contain 9 bytes (72 bits) of usable data, not counting packet sync and start code bytes, nor the message CRC byte. In some embodiments, extended messages can contain 23 bytes (184 bits) of usable data using the same criteria. Therefore, the bitrates for usable data can be further reduced to 1440 bits per second for standard messages and 1698 bits per second for extended messages. Counting only the 14 bytes (112 bits) of User Data in extended messages, the User Data bitrate is 1034 bits per second.

The devices 200 can send and receive the same messages that appear on the powerline using radio frequency signaling. Unlike powerline messages, however, messages sent by radio frequency are not broken up into smaller packets sent at powerline zero crossings, but instead are sent whole. As with power line, in an embodiment, there can be two radio frequency message lengths: standard 10-byte messages and extended 24-byte messages.

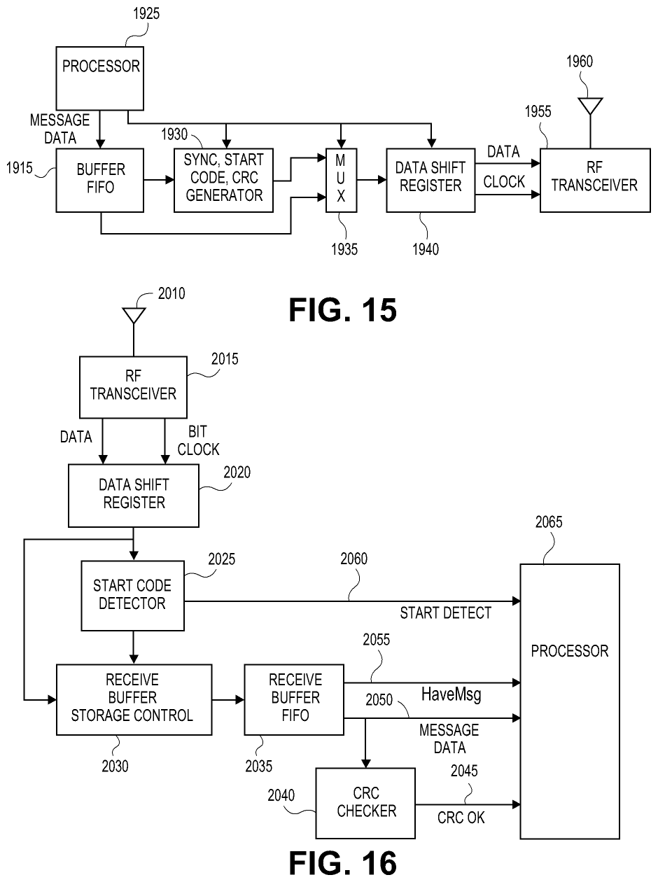

FIG. 15 is a block diagram illustrating the device 200 transmitting a message using radio frequency signaling. The steps are similar to those for sending powerline messages in FIG. 8, except that radio frequency messages can be sent all at once in a single packet. In FIG. 15, processor 1925 can compose a message to send, excluding the CRC byte, and store the message data into transmit buffer 1915. The processor 1925 can use multiplexer 1935 to add sync bits and a start code from generator 1930 at the beginning of the radio frequency message followed by data shifted out of the first-in first -out (FIFO) transmit buffer 1915.

As the message data is shifted out of FIFO 1915, a CRC generator 1930 can calculate the CRC byte, which can be appended to the bitstream by multiplexer 1935 as the last byte of the message. The bitstream can be buffered in a shift register 1940 and clocked out to the RF transceiver 1955. The RF transceiver 1955 can generate an RF carrier, translate the bits in the message into Manchester-encoded symbols, FM modulate the carrier with the symbol stream, and transmit the resulting RF signal using antenna 1960. In a preferred embodiment, the RF transceiver 1955 can be a single-chip hardware device and the other blocks in the figure can be implemented in firmware running on the processor 1925.

FIG. 16 is a block diagram illustrating the device 200 receiving a message from the radio frequency signaling. The steps are similar to those for receiving powerline messages given in FIG. 9, except that radio frequency messages can be sent all at once in a single packet. In FIG. 16, the RF transceiver 2015 can receive an RF transmission from antenna 2010 and FM demodulate it to recover the baseband Manchester symbols. The sync bits at the beginning of the message can allow the transceiver to recover a bit clock, which it uses to recover the data bits from the Manchester symbols. The transceiver can output the bit clock and the recovered data bits to shift register 2020, which can accumulate the bitstream in the message.

The start code detector 2025 can look for the start code following the sync bits at the beginning of the message and output a detect signal 2060 to the processor 2065 after it has found one. The start detect flag 2060 can enable the receive buffer controller 2030 to begin accumulating message data from shift register 2020 into the FIFO receive buffer 2035. The storage controller 2030 can insure that the FIFO 2035 only stores the data bytes in a message, and not the sync bits or start code. It can store 10 bytes for a standard message and 24 for an extended message, by inspecting the Extended Message bit in the Message Flags byte.

When the correct number of bytes has been accumulated, a HaveMsg flag 2055 can be set to indicate a message has been received. The CRC checker 2040 can compute a CRC on the received data and compare it to the CRC in the received message. If they match, the CRC OK flag 2045 can be set. When the HaveMsg flag 2055 and the CRC OK flag 2045 are both set, the message data can be ready to be sent to processor 2065. In a preferred embodiment, the RF transceiver 2015 can be a single-chip hardware device and the other blocks in the figure can be implemented in firmware running on the processor 2065.

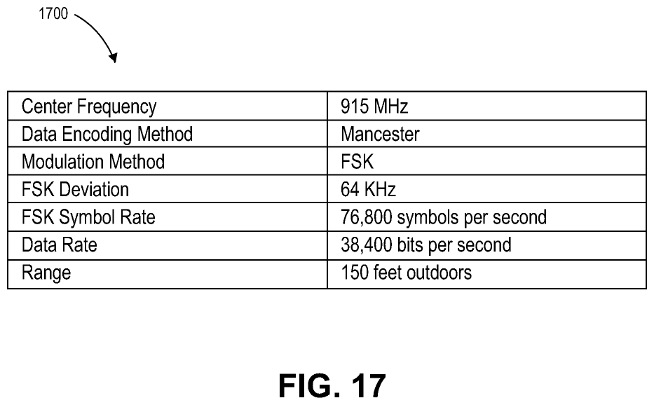

FIG. 17 is a table 1700 of exemplary specifications for RF signaling within the communication network 100. In an embodiment, the center frequency lies in the band of approximately 902 to 924 MHz, which is permitted for non-licensed operation in the United States. In certain embodiments, the center frequency can be approximately 915 MHz. Each bit can be Manchester encoded, meaning that two symbols are sent for each bit. A one-symbol followed by a zero-symbol can designate a one-bit, and a zero-symbol followed by a one-symbol can designate a zero-bit.

Symbols can be modulated onto the carrier using frequency-shift keying (FSK), where a zero-symbol modulates the carrier half the FSK deviation frequency downward and a one-symbol modulates the carrier half the FSK deviation frequency upward. The FSK deviation frequency can be approximately 64 KHz. In other embodiments, the FSK deviation frequency can be between approximately 100 KHz and 200 KHz. In other embodiments the FSK deviation frequency can be less than 64 KHz. In further embodiment, the FSK deviation frequency can be greater than 200 KHz. Symbols can be modulated onto the carrier at 38,400 symbols per second, resulting in a raw data rata of half that, or 19,200 bits per second. The typical range for free-space reception can be approximately 150 feet, which is reduced in the presence of walls and other RF energy absorbers.

In other embodiments, other encoding schemes, such as return to zero (RZ), Nonreturn to Zero-Level (NRZ-L), Nonreturn to Zero Inverted (NRZI), Bipolar Alternate Mark Inversion (AMI), Pseudoternary, differential Manchester, Amplitude Shift Keying (ASK), Phase Shift Keying (PSK, BPSK, QPSK), and the like, could be used.

Devices 200 can transmit data with the most-significant bit sent first. In an embodiment, RF messages can begin with two sync bytes comprising AAAA in hexadecimal, followed by a start code byte of C3 in hexadecimal. Ten data bytes can follow in standard messages, or twenty-four data bytes in extended messages. The last data byte in a message can be a CRC over the data bytes as disclosed above.

It takes approximately 5.417 milliseconds to send a 104-bit standard message, and approximately 11.250 milliseconds to send a 216-bit extended message. Zero crossings on the powerline can occur every 8.333 milliseconds, so a standard RF message can be sent during one powerline half-cycle and an extended RF message can be sent during two powerline half-cycles. The waiting times after sending powerline messages, as shown in FIGS. 13 and 14, are to allow sufficient time for devices 200 to retransmit a powerline message.

The devices 200 can send and receive the same messages that appear on the powerline and via RF using light modulation signaling. Unlike powerline messages, however, messages sent by light modulation are not broken up into smaller packets sent at powerline zero crossings, but instead can be sent whole, similar to the messages sent by RF. As with powerline and RF, in an embodiment, there can be two light modulation message lengths: standard 10-byte messages and extended 24-byte messages.

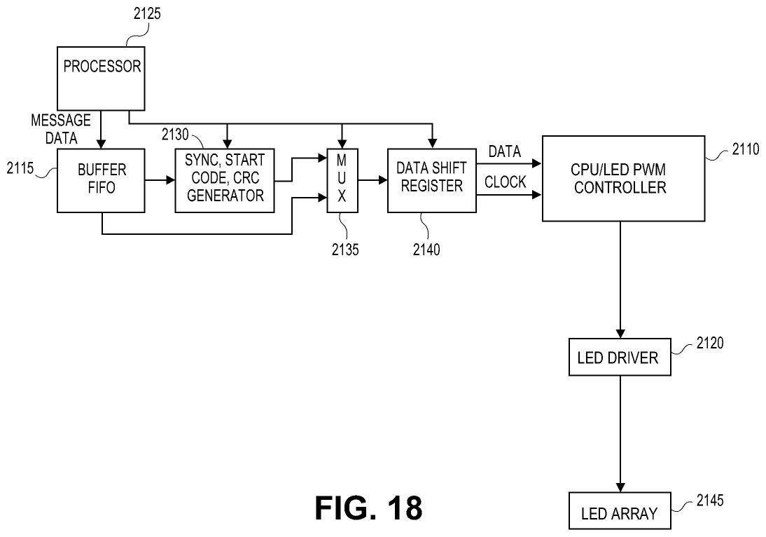

FIG. 18 is a block diagram illustrating exemplary circuitry 201 to transmit messages via modulation of light from the LED illumination device 200. The steps for transmitting are similar to those for sending RF messages, in that the messages are sent all at once in a single packet.

Processor 2125 can compose a message to send, excluding the CRC byte, and store the message data into a transmit buffer 2115. The processor 2125 can use a multiplexer 1935 to add sync bits and a start code from a generator 2130 at the beginning of the light modulation message followed by data shifted out of a first-in first-out (FIFO) transmit buffer 2115.

As the message data is shifted out of the FIFO 2115, a CRC generator 2130 can calculate the CRC byte, which can be appended to the bitstream by the multiplexer 2135 as the last byte of the message. The bitstream can be buffered in a shift register 2140 and clocked out to the LED driver 2120. In an embodiment, the LED driver 2120 can pulse wave modulate the power signal to the LED array 2125. LED array 2125 can emit pulse wave modulated light which includes the encoded message. In another embodiment, the controller 2110 and the LED driver 2120 BPSK can encode the message onto a carrier signal, such as the carrier signal used for the power line signaling, and modulate the carrier signal onto the light emitted from the LED array 2145.

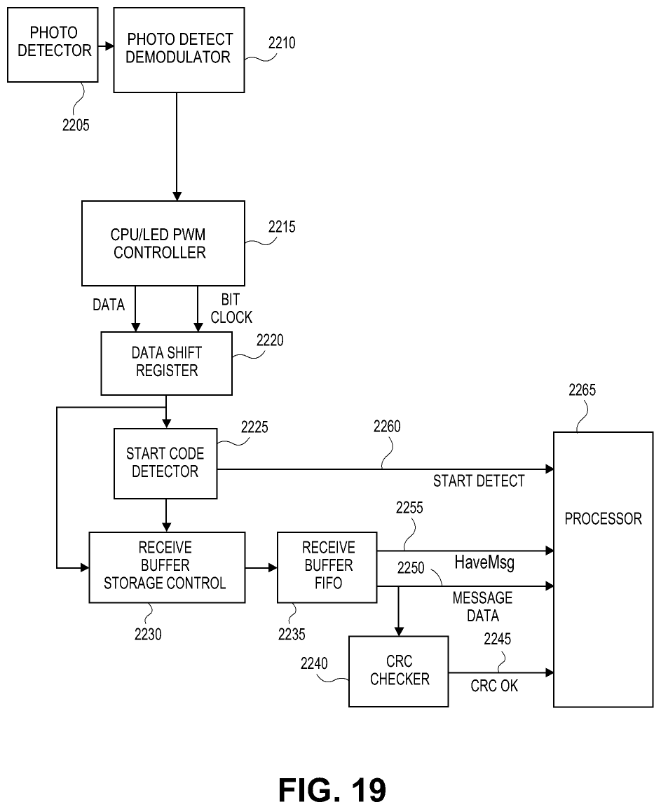

FIG. 19 is a block diagram illustrating exemplary circuitry 201 to receive messages via modulation of light from an LED illumination device 200. The steps for receiving are similar to those for sending RF messages, in that the messages are received all at once in a single packet.

Optical sensor 2205 can receive data encoded modulated light and convert the data encoded modulated light to a modulated electrical signal which is received by a photo detector demodulator 2210. The photo detector demodulator 2210 can demodulate the electrical signal to recover the data symbols.

Controller 2215 can receives the bitstream. The sync bits at the beginning of the message can allow the controller 2215 to recover a bit clock, which it uses to recover the data bits from the symbols. The controller 2215 can output the bit clock and the recovered data bits to a shift register 2220, which can accumulate the bitstream in the message.

Similar to the RF signaling circuitry, a start code detector 2225 can look for the start code following the sync bits at the beginning of the message and output a detect signal 2260 to the processor 2265 after it has found one. The start detect flag 2265 can enable a receive buffer controller 2230 to begin accumulating message data from shift register 2220 into a FIFO receive buffer 2235. A storage controller 2230 can insure that the FIFO 2235 only stores the data bytes in a message, and not the sync bits or start code. It can store 10 bytes for a standard message and 24 for an extended message, by inspecting the Extended Message bit in the Message Flags byte.

When the correct number of bytes has been accumulated, a HaveMsg flag 2255 can be set to indicate a message has been received. A CRC checker 2240 can compute a CRC on the received data and compare it to the CRC in the received message. If they match, a CRC OK flag 2245 can be set. When the

HaveMsg flag 2255 and the CRC OK flag 2265 are both set, the message data can be ready to be sent to processor 2265.

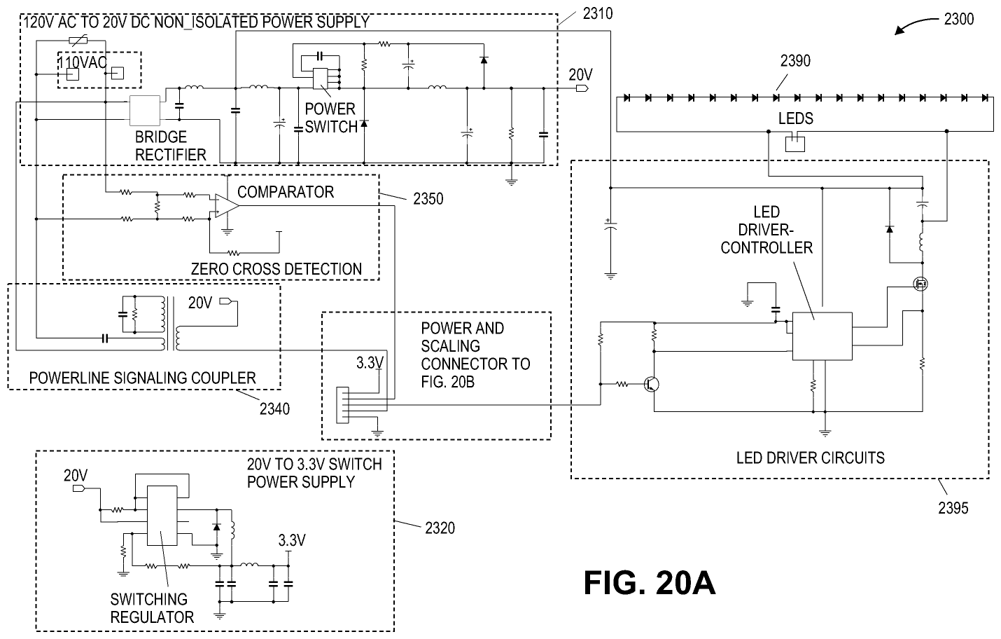

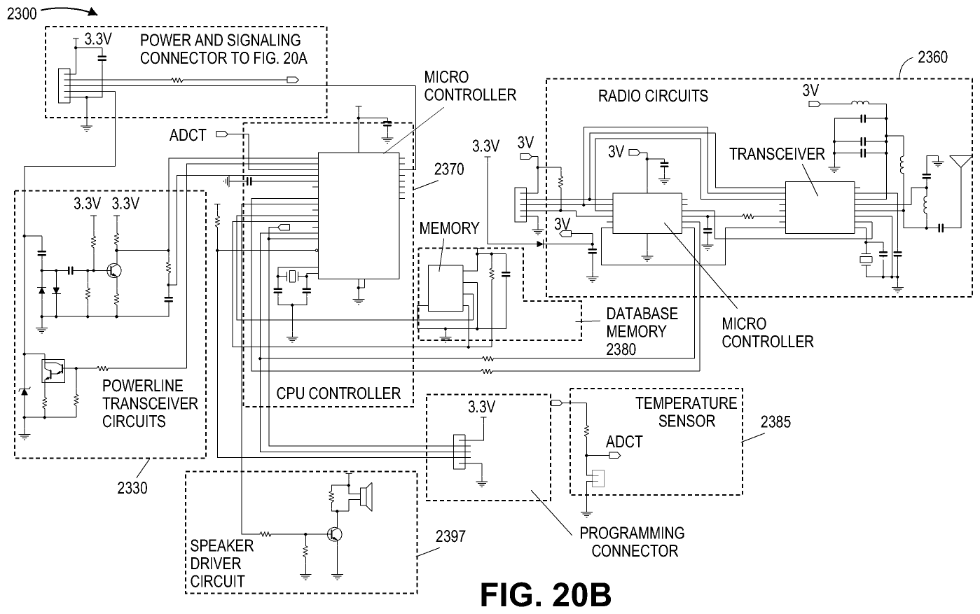

FIG. 20A and 20B are an exemplary schematic diagram of an LED illumination device 2300 configured to transmit and receive messages over the communication network 100 via powerline signaling and RF signaling, and transmit modulated light encoded messages. In an embodiment, the one or more of the circuit stages and circuit elements of FIGS. 20A and 20B can be incorporated within the glass envelope of the illumination device 2300. In the illustrated embodiment, the illumination device 2300 comprises a power supply and power line communication (PLC) interface components.

The power supply comprises a 120 VAC to 20 V non-isolated power supply 2310 and a 20 V to 3.3 V switch power supply 2320 configured to generate voltages used by the circuitry and the LED array. The power supply 2310 comprises a bridge rectifier and a power switcher, such as, for example an MB4S from Fairchild Semiconductor, Inc. and a LNK306 from Power Integrations, Inc. respectively, and the like. The power supply 2320 comprises a buck boost switching regulator, such as, for example, MC33063ADR from Texas Instruments, Inc., and the like.

The power line communication (PLC) interface components comprise a powerline transceiver circuit 2330, a powerline switching coupler 2340, and a zero crossing detector 2350. The powerline transceiver circuit 2330 can send powerline data to the controller 2370. The powerline switching coupler 2340 ca receive the line voltage. In an embodiment, the powerline switching coupler 2340 comprises a transformer such as, for example, an intermediate frequency transformer IFT-7SB-4268-05-LF having coil ratios of approximately 11/213.5/64. The zero crossing detector 2350 can detect the zero crossings of the line voltage. In an embodiment, the zero crossing detector 2350 comprises a comparator, such as, for example, a LMV321 by Texas Instruments, Inc., and the like.

The illumination device 2300 further comprises a radio circuit 2360, a CPU controller 2370 and memory 2380, an LED driver 2395, and an LED array 2390. The radio circuit 2360 can provide the RF physical layer and transmit and receive RF encoded messages. In an embodiment, the radio circuit 2360 comprises a microcontroller and a transceiver, such as for example, a PIC16F688 and a MRF49XA-I/ST by Microchip Technology, Inc., and the like.

The CPU controller 2370 can process the transmit and the receive messages. In an embodiment, the CPU controller comprises a PIC18F25J10-1/ML by Microchip Technology, Inc., and the like. The memory 2380 associate with the controller 2370 can be, for example, ROM, RAM, EEPROM, EPROM, and the like, capable of storing data and programming. In an embodiment, the memory 2380 comprises, for example, a serial EEPROM 24LC32AI/SN by Microchip Technology, Inc., and the like.

The LED driver 2395 can receive message data from the controller 2370 and can drive the LED array 2390 to transmit modulated light with the encoded message. In an embodiment, the LED driver comprises, for example, an AL9910 by Diodes, Inc., and the like. The LED array 2390 comprises one or more LEDs, such as for example, and the like.

The LED lighting module 200 optionally comprises a temperature sensor 2385 and a speaker circuit 2397. In an embodiment, the temperature sensor 2385 can be used to monitor the temperature of the device circuitry such that the controller 2370 shuts off the LEDs when the temperature is too hot. In an embodiment, the speaker 2397 can be used to notify users of overheating, to provide feedback, such as when a link with another device is established, and the like.

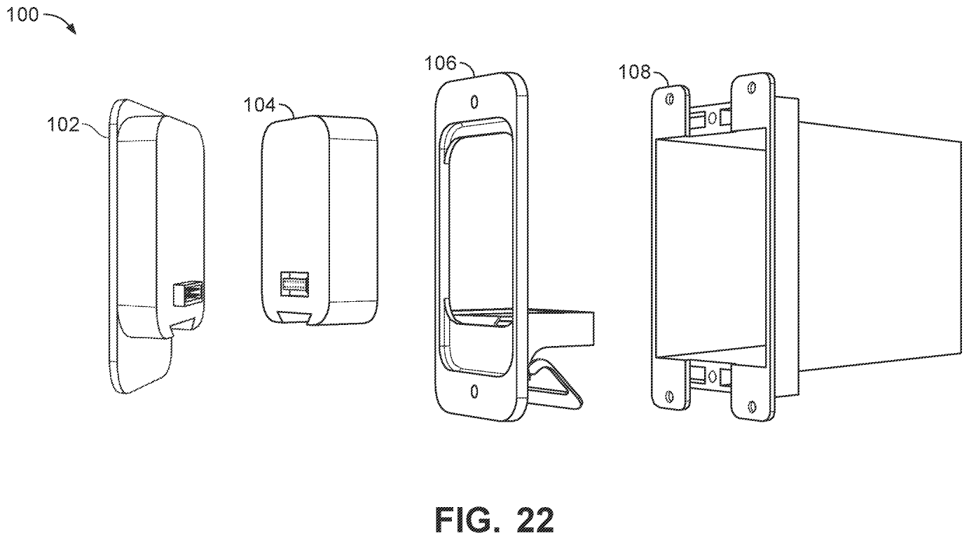

FIG. 22 illustrates an exploded view of the modular in-wall load control device 100 that, when assembled, can mount to an electrical wall box 108. In an embodiment, the modular in-wall load control device 100 comprises a user interface module 102, a load control module 104, and a backplate or mounting bracket/mounting plate 106.

### In-Wall System

Residential wiring is installed during the construction phase of home building according to the building codes. The electrical wiring connects a power source to electrical junction boxes placed throughout the house. Based on anticipated needs, some electrical junction boxes may connect to electrical devices, such as sockets, that permit direct electrical connection. Other electrical junction boxes may connect to electrical devices that control the access to the electrical power, such as switches. Once the wiring is installed, it is covered up during the finishing phase. Homeowners frequently find it difficult to repair, replace, or upgrade the existing electrical system because of concerns over safety. Further, most homeowners do not know the proper techniques to change home wiring.

Referring to FIG. 22, in an embodiment, the in-wall system 100 comprises three main pieces: the user interface module 102, the load control module 104, and the mounting bracket/mounting plate 106. The in-wall system 100 is configured to allow the homeowner/end customer to safely and easily change the load control module 104. Each location of the in-wall system 100 can be easily changed by a non-electrician.

The user interface module 102 comprises a user interface having a configurable face for receiving user input from a user to control one or more devices 202 connected to the network 200. The user interface can be one or more of a toggle switch, a paddle switch, a keypad, other switch types, a control knob, an actuation device, a feedback device to provide the user with visual and/or audible indications, such as one or more LED's, and/or a speaker. The user interface can be simplistic logic level controls allowing simple switch level control and simple logic level indicators, or can easily be replaced with high complexity and cost user interfaces such as various high density dot matrix displays (e.g., LCD, OLED, E-Ink), motion detection, voice recognition, gesture sensing, camera, and/or various environmental sensor applications.

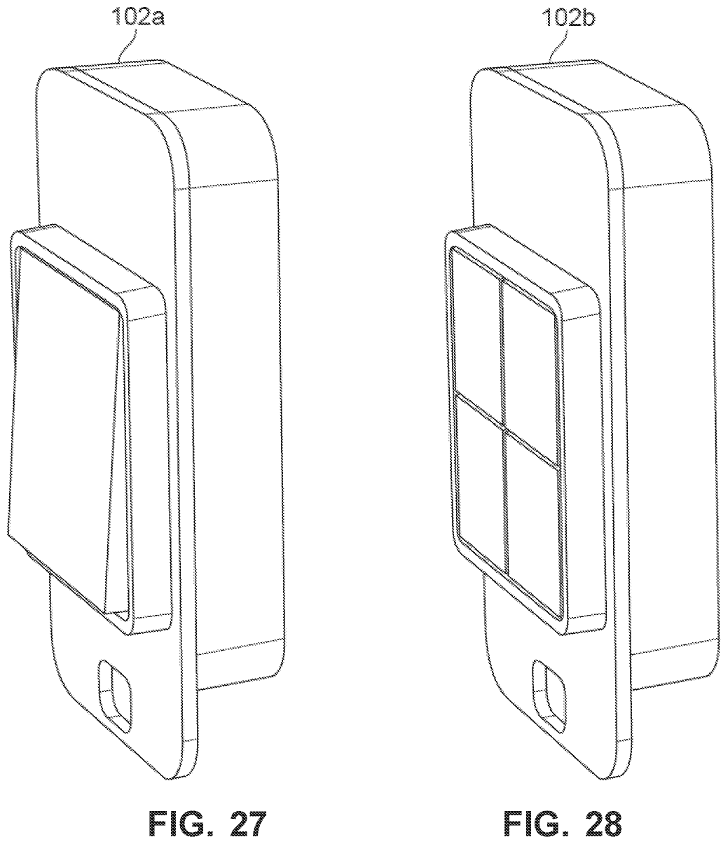

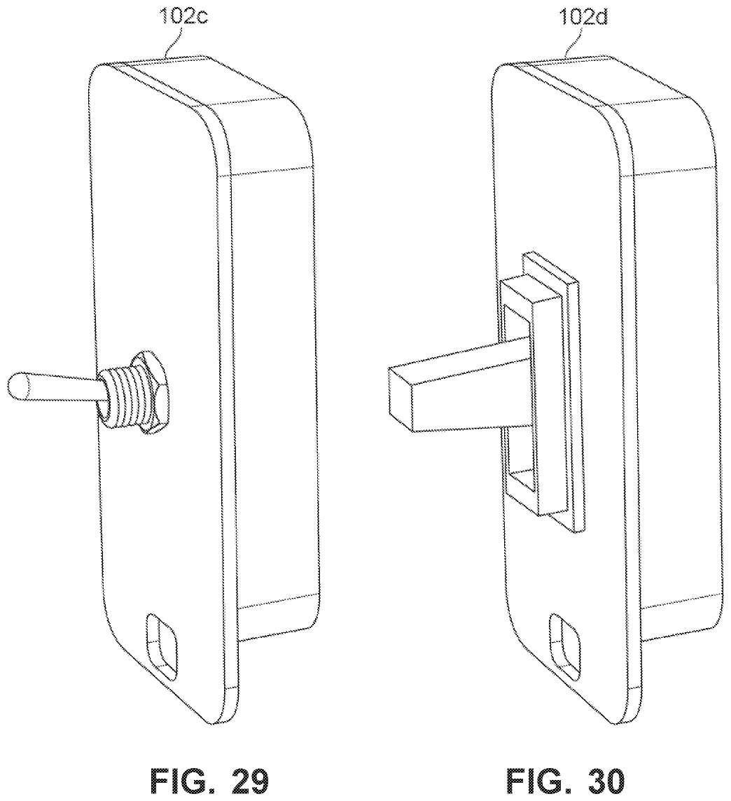

FIGS. 27-30 illustrate non-limiting examples of the configurable faces of the user interface modules 102a-102d. FIG. 27 illustrates an example of a user interface module 102a including a rocker switch; FIG. 28 illustrates an example of a user interface module 102b including a key pad; FIG. 29 illustrates an example of a user interface module 102c including a toggle switch; and FIG. 30 illustrates an example of a user interface module 102d including a switch. In some aspects, the user interface module 102 does not include RF regulatory components and does not include high voltage components. Thus, the user interface can undergo testing, such as electrostatic testing, for example, without the need for RF testing and without the need for high voltage safety testing. This allows creation of numerous user interface modules inexpensively.

In other aspects, the user interface module 102 can include a local receiver, such as the Insteon receiver local receiver and a low voltage radio, such as the control and communication devices 220 described above with respect to FIGS. 1-19.

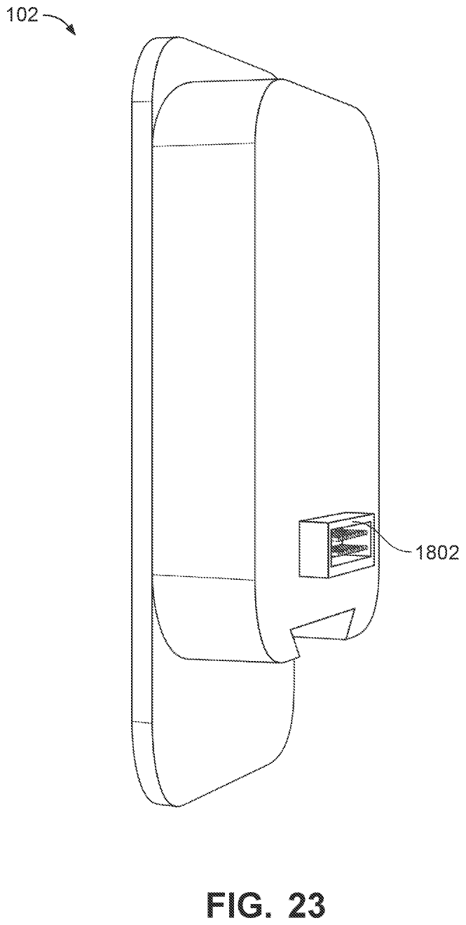

The user interface module 102 can be in electrical communication with the load control module 104. FIG. 23 illustrates a rear perspective view of an embodiment of the user interface module 102 including a connector 1802 configured to mate with the load control unit 104. Examples of the connector 1802 can be, but not limited to spring metal conductors designed to compress and maintain electrical conductivity, or conducting male pins designed to provide a compression fit into female receptacles within the Load control module, or magnetic metal conductors designed to include opposite magnetic poles to provide magnetic adhesion.

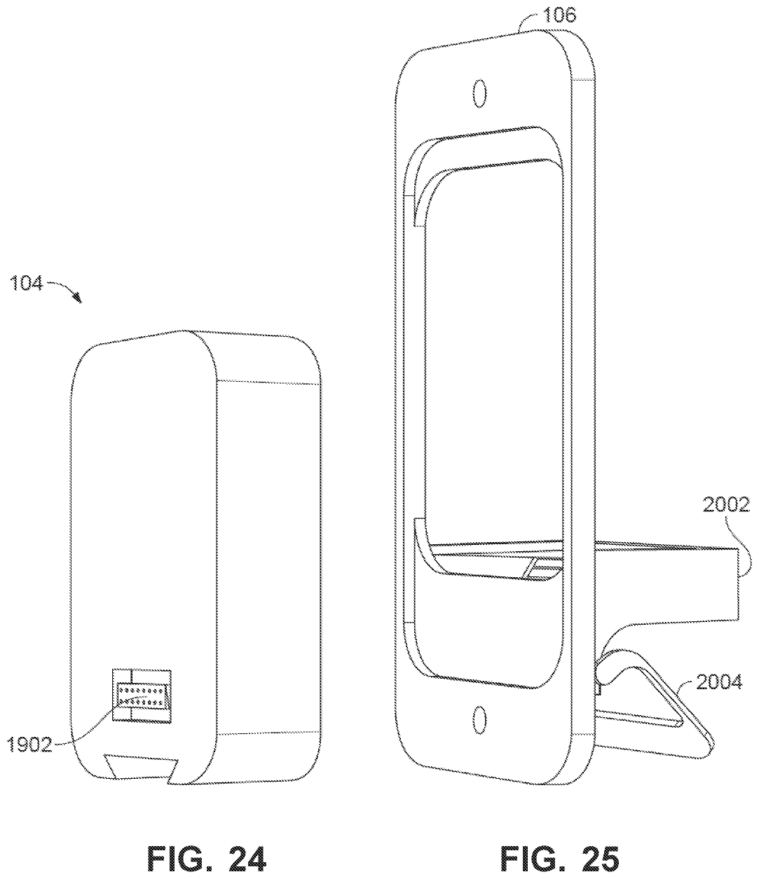

FIG. 24 illustrates a front perspective view of an embodiment of the load control module 104 including a receptacle 1902 configured to mate with connector 1802 of the user interface module 102.

In an embodiment, the load control module 104 comprises a local receiver and a low voltage radio. In certain aspects, the control and communication devices 220 described above with respect to FIGS. 1-19 comprises the local receiver and the low voltage radio. In an embodiment, the local receiver is the Insteon receiver.

The load control module 104 further comprises a power supply and a load control device (e.g., single, double, dimming or relay). In some aspects, the power supply can receive the electrical signals from the power mains which supply electrical power to the house. The power supply can also down convert the electrical signal for use in the electronic circuitry of the local receiver and low voltage radio. The load control circuitry can be configured to control the amount of power delivered to an electrical load from the AC power source, such as the power mains. In some instances the user interface signals will create a change in load control state, and in some instances it will not.

Load control can be various phase-cut dimming methods including but not limited to forward and reverse phase-cut dimming. Load control can also be via electromechanical contact closure for full conductivity or full disconnect. The load control module 104 may also allow measurement of voltage and current flow through the connected load.

The load control module 104 can be in electrical communication with the mounting bracket/mounting plate 106. FIG. 25 illustrates an embodiment of the mounting bracket/mounting plate 106 including a harness 2002 and a clamp 2004. The mounting bracket/mounting plate 106 can have a metal bracket to include the proper screws held in place by a temporary plastic holder to aid in mounting to a standard wall box 108.

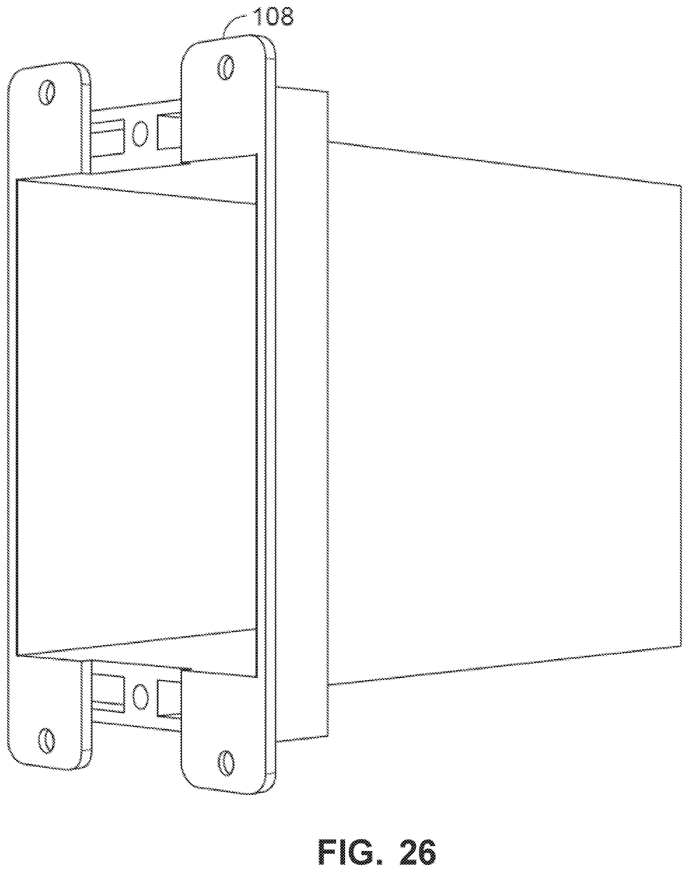

FIG. 26 illustrates an embodiment of the electrical wall box 108 that receives high voltage wiring, such as the high voltage wiring present in the high voltage cables found in residential house wiring that provide electrical service to the residence from electrical service providers. The high voltage wiring, such as the AC house wiring from the electrical wall box 108, can be in electrical communication with the mounting bracket/mounting plate 106.

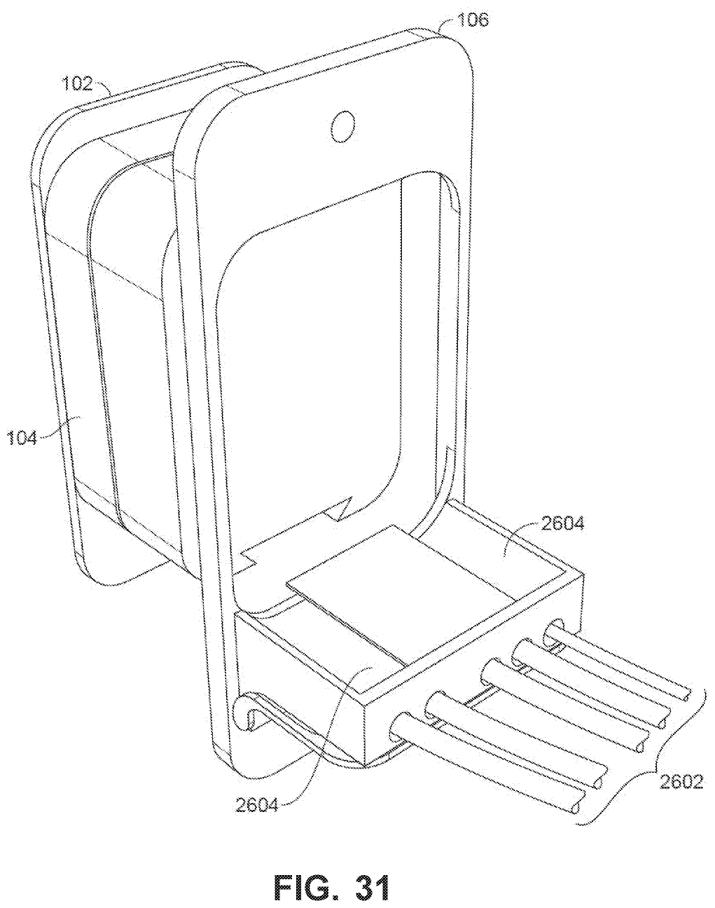

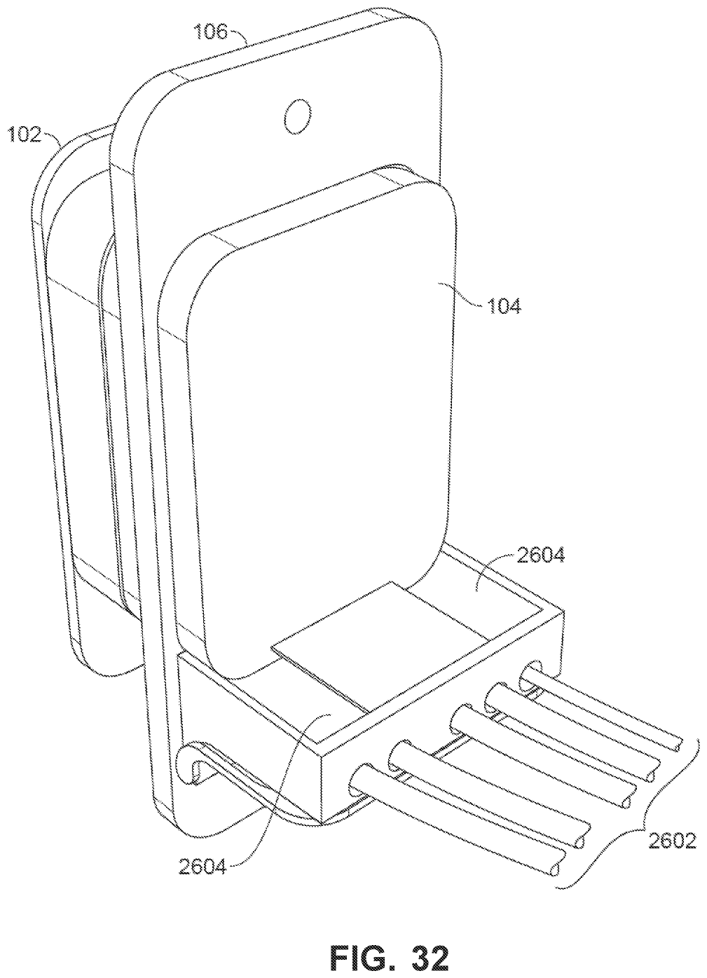

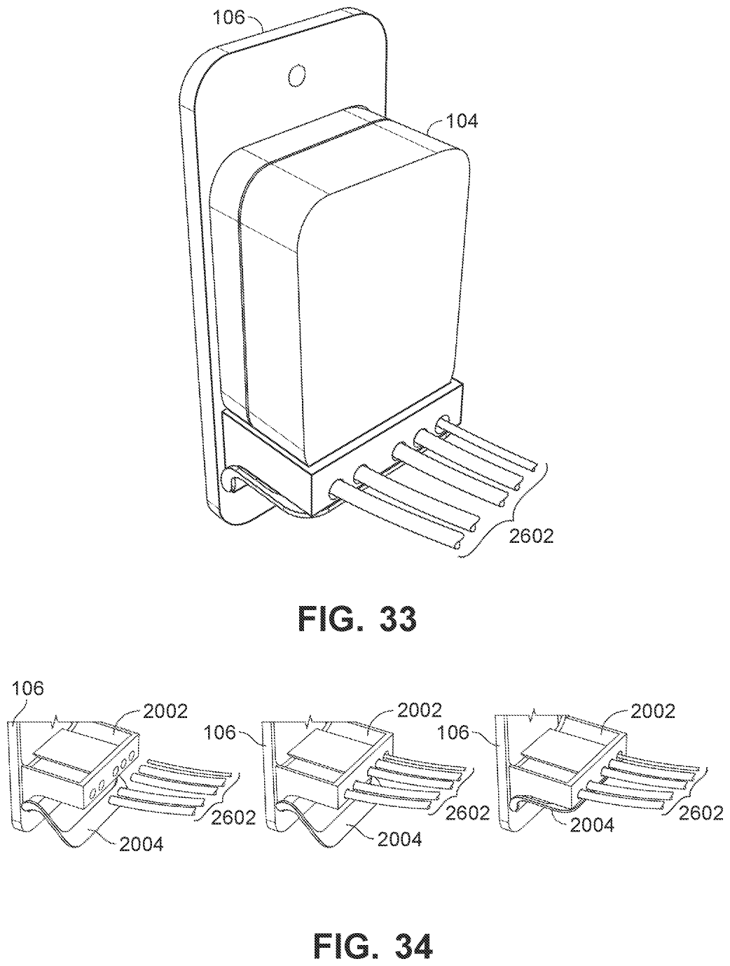

According aspects of the disclosure, FIGS. 31-33 illustrate the user interface module 102 coupled to the load control module 104 via the mating connectors 1802 and 1902 and further illustrate the assembly of the user interface module 102 and the load control module 104 sliding onto a track 2604 on the mounting bracket/mounting plate 106 to provide a secure mount and power from AC wiring 2602 to the load control module 104. The track 2604 can be formed on both sides of the mounting bracket/mounting plate 106, as illustrated in FIGS. 26-28 or the track 2604 can be provided on one of the sides of the mounting bracket/mounting plate 106 (not illustrated).

The mounting bracket/mounting plate 106 has no RF regulator components. Thus, the mounting bracket/mounting plate 106 can undergo high voltage testing without the need for RF testing.

In some aspects of the disclosure, the mounting bracket/mounting plate 106 can clamp directly onto an electrical cable including the AC wiring 2602, such as Romex®, without stripping the plastic sheath, outer wires, or individual wires. FIG. 34 illustrates an embodiment of the mounting bracket/mounting plate 106 that includes the harness 2002 and the clamp 2004. The individual wires of the AC wiring 2602 of the high voltage cable are inserted into the harness 2002 and clamped such that the clamp 2004 pierces through the insulation and locks the wires of the AC wiring 2602 in place to provide electrical connections between the mounting bracket/mounting plate 106 and the individual wires of the AC wiring 2602. In an aspect, the load control module 104 comprises a connector that mates with a corresponding connector on the mounting bracket/mounting plate 106 to provide electrical signals from the AC wiring 2602 to the load control module 104 for use in the Insteon receiver local receiver, low voltage radio, power supply, and load control device of the load control module 104.

Once the mounting bracket/mounting plate 106 is mounted to the electrical wall box 108, high voltage carried on the AC wiring 2602 would not be able to be in contact with the human finger.

The load control module 104 can identify itself to the communication network 200 via embedded memory, such as but not limited to SPI (Serial Peripheral Interface) memory, I²C (Inter-Integrated Circuit) memory, or the like, embedded in the load control module 104. In an embodiment, the memory stores an Insteon identification and specifics about the load for use by the load control module 104.

An air gap safety switch can activate when the user interface module 102 is installed. In an embodiment, a mechanical pin pushes two metal contacts together when the user interface module 102 connects to the load control module 104 to activate the air gap switch.

Conversely, when the user interface module 102 is removed from the load control module 104, the metal contacts have a spring tension that causes them to separate mechanically, to deactivate the air gap switch. Advantageously, it can be safer to de-energize the load control module 104 when user interface module 102 is removed.

In some embodiments, the one load control module 104 supports dimming, on/off, and 2 wire (neutral-less) load control capabilities.

In some embodiments, the load control module 104 comprises a pull-tab for removal, or other means of releasing the load control module 104.

In some embodiments, the load control module 104 comprises a magnetic catch that locks the load control module 104 in place.

In some embodiments, the user interface module 102 acts as a lock-in place for the load control module 104.

In some embodiments, the in-wall module 100 further comprises an indication that the load control module 104 is properly installed and functional. In some embodiments, the indication indicates that the load is not controllable, but the power supply is active.

In some embodiments, the in-wall module 100 is configured to dampen the effect of installing the load control module 104 and releasing it.

Advantageously, the homeowner/end customer can safely and easily change the user interface module 102. In some embodiments, the changeable user interface module 102 allows the user to change user interfaces as desired, without un-powering the electrical wall box wiring.

Inter changeable Communication Device

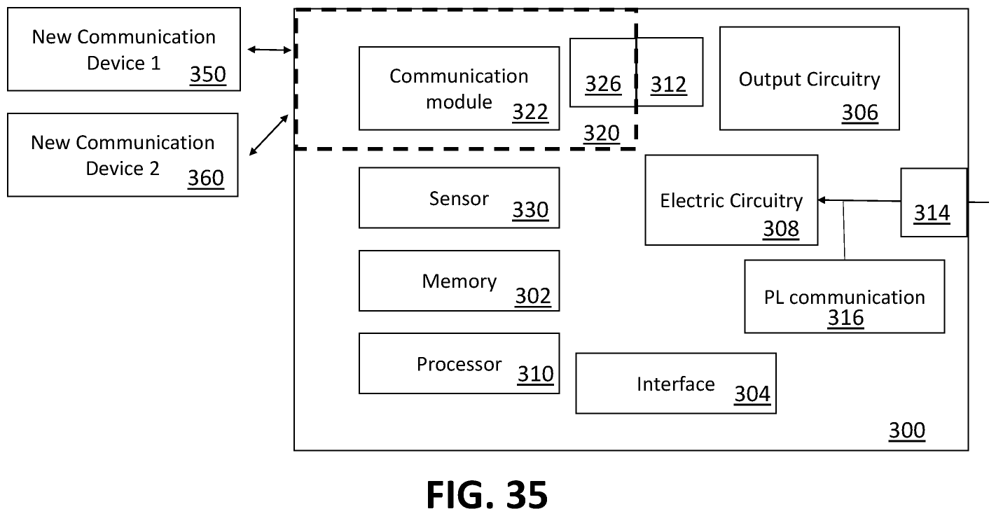

FIG. 35 is a block diagram illustrating a device 300 according to certain embodiments. The device 300 can be similar to one of the devices 116-126. The device 300 can be registered within a network to communicate with other devices. The device 300 can comprise an enclosure (not illustrated), a controller or a processor 310, a memory 302, an interface 304, output circuitry 306, a first connector 314, powerline communication circuitry 316, a second connector 312, electric circuitry 308, an interchangeable communication device 320 and a sensor 330. The memory 302 can store data and executable instructions that when executed by processor 310 cause the processor 310 to perform certain actions. The processor 310 can include a memory. The executable instructions can be stored in the memory of the processor 310. The electric circuitry 308 can be connected to an external power source via the first connector 312. For example, the external power source can be an alternating current power source. In an embodiment, the electric circuitry 308 can convert the alternating current from the external power source to direct current and supply the direct current to the output circuitry 306, memory 302, the interface 304, the processor 310 and the interchangeable communication device 320. The second connector 312 can be exposed from the enclosure. Another module/device such as the interface 304, one or more processors, etc, can be connected to the second connector 312. The interface 304 or the interchangeable communication device 320 can includes a display or an indicator for providing visual feedback to a user. For example, the display or the indicator can comprise dot matrix using LED, OLED and LCD, etc. The visual feedback can comprise time, date and home status such as door/window open/close, door lock status, light level of each area, heating/cooling status, etc. Further, the visual feedback can comprise a group of home device.

The output circuitry 306 can represent function as home appliance such as an illumination device, a television, a speaker, a massage machine, an air-conditioner, a modem, a washing machine, a dryer, etc. The sensor can detect conditions such as light, brightness level, sound, humidity, pressure, temperature, image, smoke, etc. The sensor 330 may comprise at least one of a light detector sensor, a motion detector sensor (e.g., infra-red detector, Radar detector), a sound detection sensor, a pressure detection sensor, a smoke detection sensor, an image detector (e.g., camera), a temperature detection sensor, a humidity detection sensor, etc. In an embodiment, the motion detector senor can perform an occupancy detection, a movement detection, counting people and a position detection (e.g., approach of a person). For example, when a user approaches to a wall switch, the motion sensor can detect the approach and provide control signals to the processor 310. The processor 310 can control brightness of the indicator included in the interface 304 in response to the control signals. The sound detection sensor perform noise detection, alarm detection. The pressure detection sensor can detect a glass break, a door/window open/close. The image detector can perform an image recognition for the occupancy detection and specific person recognition. The processor 310 can receive coded messages and/or processed messages from the communication device 320. The processor 310 can process the coded messages to provide control signals.

A user can interchange the communication device 320 with a new communication device 350 or 360. The interchangeability is illustrated as a dashed line in FIG. 35 for illustration purposes. A communication protocol of the communication device 320 can be different from that of the new communication device 350 or 360. The communication protocol can comprise home automation protocols, a mesh network protocol, a Lora protocol, an RF protocol, Bluetooth, a near-field communication protocol, Wi-Fi, a 4G LTE protocol and a 5G wireless protocol, etc. The communication protocol can be a proprietary protocol. For example, the RF protocol can use RF band such as 315 MHz, 2.5 GHz, 5 GHz, unlicensed bands, etc. The communication protocol can comprise various communication mediums (e.g., light, sound) or communication layer described herein. The home automation protocol can comprise Zigbee, Zwave, Insteon, KNX, Thread, etc. The communication protocol may comprise a telecommunication protocol to be developed in the future. Accordingly, the user 300 can select the communication protocol of the device 300 without buying a new device by interchanging the communication device 320 with a new communication device.

The communication device 320 may comprise a communication module 322 and a third connector 326. The communication device 320 can be connected to the device 300 via the third connector 326 and the second connector 312. The third connector 326 can be detachably coupled to the second connector 312. Each of the second and the third connector 312, 326 can comprises any type of a physical connector, for example, a slot, a port such as USB port, a coaxial cable connector, a fiber-optic connector, the connector 1802, etc.

When the communication device 320 is connected to the device 300, the processor 310 can communicate with the communication module 322 automatically. For example, the communication device 320 and the device 300 can communicate with the plug and play method.

The processor 310 can register a communication protocol of the communication device 320 within the network. The communication device 320 can receive coded messages from and transmit coded messages to another network device using its own communication protocol. In an embodiment, the communication device 320 can comprise a processor and a memory. The processor of the communication device 320 can perform similar functions to the processor 310. The processor of the communication device 320 can process the coded messages and send the processed coded messages to the device 300. The processor of the communication device 320 can provide control signals to the device 300. When a user interchanges the communication device with new communication device, the processor 310 can communicate with the new communication module automatically. For example, the processor 310 can recognize the new communication module automatically. The processor 310 can retrieve information from a memory of the new communication module. The information can comprise an identifier of the new communication module and/or instructions for operating the communication protocol of the new communication module. The processor 310 can store the retrieved information therein. The new communication device and the device 300 can communicate with the plug and play method. A communication protocol of the new communication device can be registered within the network via its own protocol and/or the powerline signaling via the powerline communication circuitry 316. The universal plug and play technology can be applied. The device 300 or the new communication device can establish working configurations with other devices within the network. In an embodiment, at least one of the sensor 330, the processor 310, the powerline communication circuitry 316, the interface 304, the memory 302 can be omitted from the device 300.

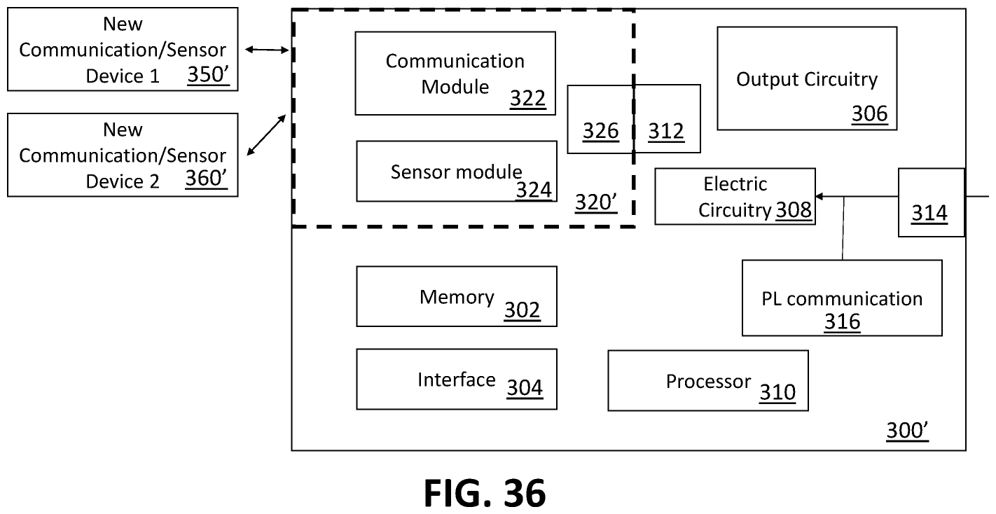

FIG. 36 is a block diagram illustrating a device 300′ according to certain embodiments. The device 300′ is similar to the device 300 in FIG. 35 except that the communication device 320′ further comprises a sensor module. The sensor module 324 is similar to the sensor 330. A user can interchange the communication device 320′ with a new communication/sensor device 350′ or 360′. The interchangeability is illustrated as a dashed line in FIG. 36 for illustration purposes. Sensing results from the sensor 330 can be transmitted to the processor 310 via the second and the third connectors 312, 326. Alternatively, the sensing results from the sensor 330 can be transmitted to the processor of the communication module 322.

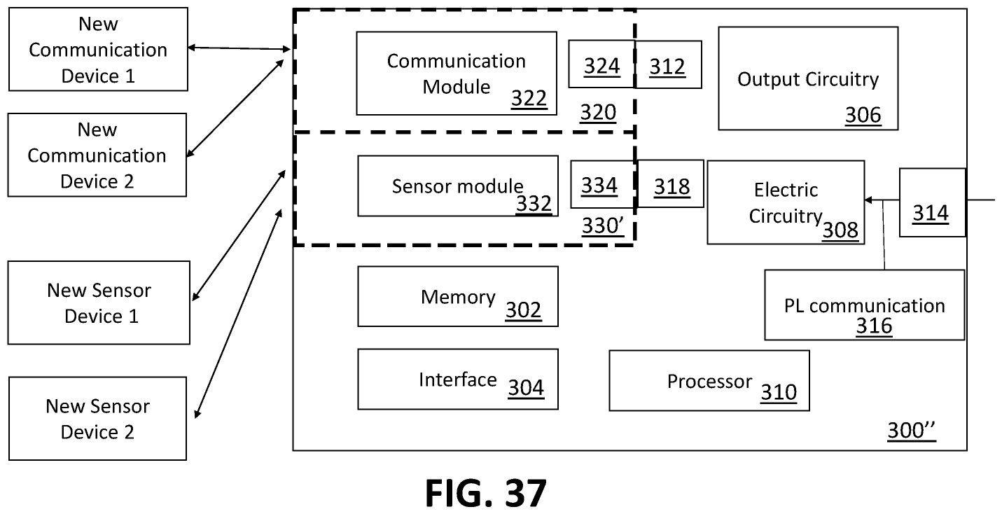

FIG. 37 is a block diagram illustrating a device 300″ according to certain embodiments. The device 300″ is similar to the device 300 in FIG. 35 except that the device 300″ further comprises a fourth connector 318 for connecting the device 300″ with other modules/devices and a sensor module 332 that can be interchanged with a new sensor module separately. The sensor module 332 comprises a fifth connector 334 that can be coupled to the fourth connector 318. The interchangeability is illustrated as dashed lines in FIG. 37 for illustration purposes. Sensing results from the sensor 330′ can be transmitted to the processor 310 via the fourth and the fifth connectors 318, 334. Alternatively, the sensing results from the sensor 330′ can be transmitted to the processor of the communication module 322.

### Terminology

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The words “coupled” or connected”, as generally used herein, refer to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The words “coupled” or connected”, as generally used herein, refer to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The above detailed description of certain embodiments is not intended to be exhaustive or to limit the invention to the precise form disclosed above. While specific embodiments of, and examples for, the invention are described above for illustrative purposes, various equivalent modifications are possible within the scope of the invention, as those ordinary skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the systems described above. The elements and acts of the various embodiments described above can be combined to provide further embodiments.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A system to receive and transmit data and commands over a network, the system comprising:
a mesh network; and
a plurality of network devices, each network device comprising:
an enclosure;
a first connector mounted in the enclosure and configured to connect to an electric power source;
a second connector exposed from the enclosure;
a communication device including:
a sensor module configure to detect a first condition;
a communication module configured to receive coded messages from and transmit coded messages to another network device over the mesh network using a first communication protocol;
a third connector configured to detachably couple to the second connector; and
wherein the communication device is configured to be interchangeable with another communication device of a plurality of communication devices that use a second communication protocol that is different from the first communication protocol; and
a controller in communication with the communication module and comprising processing circuitry configured to control operations of the network device responsive to a message received from the communication module.

2. The system of claim 1, wherein the network device further comprises powerline communication circuitry configured to receive messages from and transmit messages over the mesh network via the first connector, the messages being modulated onto a carrier signal and the data modulated carrier signal being added to the powerline waveform.

3. The system of claim 2, wherein each of the network devices is configured to transmit and receive the coded messages synchronously over the mesh network using powerline signaling and the first communication protocol based on zero crossings of the powerline waveform.

4. The system of claim 1, wherein each of the first and the second communication protocols include at least one of a home automation protocol, a mesh network protocol, an RF protocol, Bluetooth, a near-field communication protocol, Wi-Fi, a 4G LTE protocol and a 5G wireless protocol.

5. The system of claim 1, wherein the controller comprises a memory, the controller being configured to communicate with said another communication device to retrieve information from said another communication device and to store the information in the memory in response to determining that the communication device is interchanged with said another communication device.

6. The system of claim 1, wherein the network device comprises a fourth connector exposed from the enclosure and wherein the sensor module further comprises a fifth connector detachably coupled to the fourth connector to allow interchangeability of the sensor module with another sensor module that is configured to detect a second condition that is different from the first condition.

7. The system of claim 1, wherein at least one of the network devices is an in-wall modular assembly comprising a mounting bracket configured to attach to an electrical box that is mounted in a house, the mounting bracket being configured to electrically connect to the first connector.

8. A network device to receive and transmit data and commands over a network, the network device comprising:
an enclosure;
a first connector mounted in the enclosure and configured to connect to an electric power source;
a second connector exposed from the enclosure;
a communication device including:
a communication module configured to receive coded messages from and transmit coded messages to another network device over the mesh network using a first communication protocol;
a third connector configured to detachably couple to the second connector; and
wherein the communication device is configured to be interchangeable with another communication device of a plurality of communication devices that use a second communication protocol that is different from the first communication protocol; and
a controller in communication with the communication module and comprising processing circuitry configured to control operations of the network device responsive to a message received from the communication module.

9. The network device of claim 8, further comprising powerline communication circuitry configured to receive messages from and transmit messages over a mesh network via the first connector, the messages being modulated onto a carrier signal and the data modulated carrier signal being added to the powerline waveform.

10. The network device of claim 9, wherein each of the network devices is configured to transmit and receive the coded messages synchronously over the mesh network using powerline signaling and the first communication protocol based on zero crossings of the powerline waveform.

11. The network device of claim 9, wherein the carrier signal has a first frequency and the first communication protocol is radio frequency (RF) signaling, the RF signaling having a second frequency different from the first frequency.

12. The network device of claim 8, wherein the communication device further comprises a sensor module.

13. The network device of claim 8, further comprising a sensor module that is configured to detect a first condition and a fourth connector exposed from the enclosure and wherein the sensor module further comprises a fifth connector detachably coupled to the fourth connector configured to allow interchangeability of the sensor module with another sensor module that is configured to detect a second condition that is different from the first condition.

14. The network device of claim 8, wherein each of the first and the second communication protocols include at least one of a home automation protocol, a mesh network protocol, an RF protocol, Bluetooth, a near-field communication protocol, Wi-Fi, a 4G LTE protocol, and a 5G wireless protocol.

15. The network device of claim 8, wherein the controller comprises a memory, the controller being configured to communicate with said another communication device to retrieve information from said another communication device and to store the information in the memory in response to determining that the communication device is interchanged with said another communication device.

16. The network device of claim 8, wherein the network device is an in-wall modular assembly comprising a mounting bracket configured to attach to an electrical box that is mounted in a house, the mounting bracket being configured to electrically connect to the first connector.

17. A method to receive and transmit data and commands over a home network, the method comprising:
receiving, with a first connector of a first network device, electrical power;
supplying power to the first network device;
receiving, with a communication module of the first network device that uses a first communication protocol, coded messages from a second network device, the communication module configured to detachably couple from the first network device to allow the communication module to be interchanged with another communication module that uses a second communication protocol that is different from the first communication protocol;
processing the coded messages to provide control signals;
controlling operations of the first network device in response to the control signals; and
transmitting, with the communication module, the coded messages to a third network device over the home network.

18. The method of claim 17, further comprising receiving the coded messages from and transmitting the coded messages to the second network device using powerline signaling.

19. The method of claim 17, wherein each of the first and the second communication protocols include at least one of a home automation protocol, a mesh network protocol, an RF protocol, Bluetooth, a near-field communication protocol, Wi-Fi, a 4G LTE protocol and a 5G wireless protocol.

20. The method of claim 17, further comprising:
determining whether the communication module is interchanged with said another communication module; and
retrieving information from said another communication module in response to the determination; and
storing the information in a memory of the first network device.
